(19) United States
(12) Patent Application Publication
(10) Pub. No.: US 2026/0226281 A1
(43) Pub. Date: Aug. 6, 2026

(54) AQUEOUS COATING COMPOSITION AND METHOD OF PREPARING COATING

(71) Applicant: DOW GLOBAL TECHNOLOGIES LLC, Midland, MI (US)

(72) Inventors: Hu LI, Shanghai (CN); Jia TANG, Shanghai (CN); Baoqing ZHENG, Shanghai (CN)

(21) Appl. No.: 19/149,642

(22) PCT Filed: Feb. 28, 2023
(86) PCT No.: PCT/CN2023/078642

§ 371 Date: Jul. 21, 2025

(51) Int. Cl. C09D 5/02; C08F 212/08; C08K 3/34; C08K 5/092; C08K 5/1545; C08K 5/25; C08K 5/5317; C08K 13/02; C09D 5/08; C09D 7/61; C09D 7/63; C09D 125/14; C23F 11/173

(52) U.S. Cl. CPC C09D 5/022; C08F 212/08; C09D 5/028; C09D 5/084; C09D 5/086; C09D 7/61; C09D 7/63; C09D 125/14; C23F 11/173; C08K 2003/343; C08K 5/092; C08K 5/1545; C08K 5/25; C08K 5/5317; C08K 13/02

(57) ABSTRACT

An aqueous coating composition contains: (A) an emulsion polymer comprising structural units from monomers based on total weight of the monomers (i) 0.48-1.5 wt % of an ethylenically unsaturated phosphorous-containing monomer, (ii) 0.7-32 wt % of diacetone (meth)acrylamide, (iii) 10-80 wt % of a vinyl aromatic monomer, (iv) an alkyl (meth)acrylate, and (v) 0-5 wt % of an α, β-ethylenically unsaturated carboxylic acid, a salt thereof, or mixtures thereof; (B) a specific dicarboxylic acid, a salt thereof, or mixtures thereof at a specific concentration; (C) 30-60 wt % of a thio-, amido-, or imido-derivative of triphosphonic acids, a salt thereof, or mixtures thereof; (D) a water-soluble alkali metal silicate to provide a dry weight ratio of (D):(C) of 1.2 to 3.7; and (E) from 40-52 wt % of tannic acid, gallic acid, pyrogallol, or citric acid; a salt thereof; or combinations thereof; where weight percentages are relative to the emulsion polymer weight. A method using such composition as a base coat.

### FIELD

The present invention relates to an aqueous polymer composition and a method of preparing a coating.

### INTRODUCTION

Solvent-borne coating compositions comprising epoxy resins, polyurethanes, or alkyd resins are widely used in metal protective coatings due to their anti-corrosion performance, mechanical properties, and appearance. Waterborne coating compositions comprising acrylic polymers have much less environmental concerns than solvent-borne coating composition. However, shortly or instantly after applying waterborne coating compositions to a corrosion susceptible substrate (such as a metal substrate) and before thoroughly drying the compositions, flash rust tends to form on metal surfaces as discrete rust spots visible to the naked eye (known as “flash rusting”). Efforts have been made to develop waterborne coating compositions with improved flash rust resistance. Addition of sufficient amounts of flash rust inhibitors such as sodium nitrite into waterborne coating compositions can reduce or eliminate the formation of flash rust on the metal surface, but usually hurts early water resistance properties of coatings made therefrom. Furthermore, waterborne coating compositions known from the prior art, when drying, typically lack sufficient adhesion to unpretreated metal substrates such as rusted metal surfaces. Therefore, metal surfaces usually need to be pretreated to ensure sufficient adhesion between coatings and the substrate, e.g., through polishing metal surfaces to remove rust or by applying rust conversion paints onto rusted metal surfaces. Traditional rust conversion paints typically use rust-conversion agents such as tannic acid or phosphoric acid to react with rust, thereby forming a stable non-soluble coordination compound on the metal surface. Such coordination compound, acting as a base coat on which a waterborne top coating composition can be further applied, may help with corrosion resistance improvement while having no benefit in improving flash rust resistance properties of coatings made therefrom. As these acidic rust conversion paints usually are not compatible with most waterborne acrylic polymers that are more stable in basic conditions and films of the coordination compound are still not dense enough, the coatings still show insufficient adhesion to the metal substrate.

Therefore, there remains a need to provide an aqueous coating composition that can be directly applied onto a corrosion susceptible substrate, at the same time, can provide coatings made therefrom with desirable flash rust resistance, early water resistance, and adhesion properties.

### SUMMARY

The present invention provides a novel aqueous coating composition without the aforementioned problems. The aqueous coating composition of the present invention comprises a novel combination of at least components (A) to (E): (A) a specific emulsion polymer; (B) a specific dicarboxylic acid, a salt thereof, or mixtures thereof; (C) a thio-, amido-, or imido-derivative of triphosphonic acids, salts thereof, or mixtures thereof; (D) a water-soluble alkali metal silicate; and (E) tannic acid, gallic acid, pyrogallol, citric acid, salts thereof, or combinations thereof. The aqueous coating composition can be directly applied to a corrosion susceptible substrate (particularly, an unpretreated substrate), while providing coatings made therefrom with excellent flash rust resistance with flash rust grades of “0”, good early water resistance with blister ratings of “8M” or better, and good adhesion to the substrate with adhesion classifications >4B. These properties can be measured according to the test methods described in the Examples section below.

In a first aspect, the present invention is an aqueous coating composition comprising,
(A) an emulsion polymer comprising: (i) from 0.48% to 1.5% by weight of structural units of an ethylenically unsaturated phosphorous-containing monomer, (ii) from 0.7% to 3% by weight of structural units of diacetone (meth)acrylamide, (iii) from 10% to 80% by weight of structural units of a vinyl aromatic monomer, (iv) structural units of an alkyl (meth)acrylate, and (v) from zero to 5% by weight of structural units of an α, β-ethylenically unsaturated carboxylic acid, a salt thereof, or mixtures thereof;
(B) a dicarboxylic acid, a salt thereof, or mixtures thereof; wherein the dicarboxylic acid has the structure of formula (I): HOOC—R—COOH; where R is alkylene, alkenylene, alkynylene, cycloalkylene, cycloalkenylene, cycloalkynylene, arylene, or heterocyclic arylene; containing 6 to 18 carbon atoms; and wherein (B) the dicarboxylic acid, the salt thereof, or mixtures thereof is present in an amount to provide —OOC—R—COO— segments at a concentration of from 1.1% to 3.8% by weight;
(C) from 30% to 60% by weight of a thio-, amido-, or imido-derivative of triphosphonic acids, a salt thereof, or mixtures thereof;
(D) a water-soluble alkali metal silicate that is present in an amount to provide a dry weight ratio of (D) the water-soluble alkali metal silicate to (C) the thio-, amido-, or imido-derivative of triphosphonic acids, the salt thereof, or mixtures thereof, of 1.2 to 3.7; and
(E) from 40% to 52% by weight of tannic acid, gallic acid, pyrogallol, or citric acid; a salt thereof; or combinations thereof;
where weight percentages are relative to the emulsion polymer weight.

In a second aspect, the present invention is a method of preparing a coating, comprising:
(i) providing the aqueous coating composition of the first aspect,
(ii) applying the aqueous coating composition directly on a corrosion susceptible substrate, and
(iii) drying, or allowing to dry, the applied aqueous coating composition, thereby forming a base coat on the substrate; and optionally,
(iv) applying an aqueous top coating composition comprising an acrylic emulsion polymer to the base coat obtained from step (iii); and (v) drying, or allowing to dry, the applied aqueous top coating composition to form a top coat, such that the base coat resides between the substrate and the top coat.

### DETAILED DESCRIPTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods, ISO refers to International Organization for Standards, and GB/T refers to China National Standard. Products identified by their tradename refer to the compositions available under those tradenames on the priority date of this document. “And/or” means “and, or as an alternative”. All ranges include endpoints unless otherwise indicated.

“Untreated surface” and “unpretreated substrates” both refer to substrate surfaces which are used entirely without pretreatment or substrate surfaces which prior to the application of the aqueous coating composition of the present invention have been cleaned to remove dust, loose rust, contaminants, and grease. Any such cleaning takes place, for example, only with evaporating solvents and/or with burnishing to remove loose rust. There is no additional treatment or priming of the substrate surfaces with rust conversion compositions (other than the aqueous coating composition of the present invention) before the aqueous coating composition of the present invention is applied. “Loose rust” means rust that can be peeled by hand without the aid of a tool.

“Aqueous” composition or dispersion herein means that particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, or mixtures thereof.

“Acrylic polymer” herein refers to a homopolymer of an acrylic monomer or a copolymer comprising structural units of an acrylic monomer with one or more additional monomers. “Acrylic” in the present invention includes (meth)acrylic acid, alkyl (meth)acrylate, (meth)acrylamide, (meth)acrylonitrile and their modified forms such as hydroxyalkyl (meth)acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate. Acrylic polymers may include acrylic homopolymers, styrene acrylic copolymers, or mixtures thereof.

“Structural units”, also known as “polymerized units”, of the named monomer, refers to the remnant of the monomer after polymerization, that is, polymerized monomer or the monomer in polymerized form. For example, a structural unit of methyl methacrylate is as illustrated:

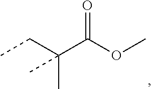

where the dotted lines represent the points of attachment of the structural unit to the polymer backbone.

“Alkylene” means a branched or unbranched, saturated divalent hydrocarbon group. Exemplary alkylene groups include methylene (—CH₂—), ethylene (—CH₂CH—), —CH₂CH(CH₃)CH₂—, or combinations thereof. “Cycloalkylene” means a branched or unbranched, divalent hydrocarbon group connecting with one or more cycloalkyl groups. Exemplary cycloalkylene groups include cyclohexylene, methylcyclohexylene, or combinations thereof. “Alkenylene” means a branched or unbranched, bivalent hydrocarbon group having one or more carbon-carbon double bonds. Exemplary alkenylene groups include ethenylene (—CH═CH—), —CH═CH—CH₂—, —CH═C(CH₃)—, or combinations thereof. “Cycloalkenylene” means a branched or unbranched, bivalent hydrocarbon group having one or more carbon-carbon double bonds connecting or within one or more cycloalkyl groups. Exemplary cycloalkenylene groups include cyclohexenylene, —CH═CH—C₆H₁₀—, or combinations thereof. “Alkynylene” means a branched or unbranched, bivalent hydrocarbon group having one or more carbon-carbon triple bond. Exemplary alkynylene groups include ethynylene, —C═C—, —C═C—CH₂—, or combinations thereof. “Cycloalkynylene” means a branched or unbranched, bivalent hydrocarbon group having one or more carbon-carbon triple bonds connecting or within one or more cycloalkyl groups. Exemplary cycloalkynylene groups include —C═C—C₆H₁₀—, or combinations thereof. “Arylene” means a branched or unbranched, bivalent hydrocarbon group connecting with one or more aryl groups. Exemplary arylene groups include phenylene, —C₆H₄—, —CH₂—C₆H₄—, —CH₂—C₆H₃(CH₃)—, or combinations thereof. “Heterocyclic arylene” means a branched or unbranched, bivalent hydrocarbon group connecting with one or more heterocyclic aryl groups. Exemplary heterocyclic arylene groups include pyridylene, thiazylene, or combinations thereof.

“Glass transition temperature” or “T_{g}” as used herein can be calculated by using a Fox equation (T.G. Fox, Bull. Am. Physics Soc., Volume 1, Issue No. 3, page 123 (1956)) below. For example, for calculating the T_{g} of a copolymer of monomers M₁ and M₂,

$$\frac{1}{{T}_{g} ( calc . )} = \frac{w ( {M}_{1} )}{{T}_{g} ( {M}_{1} )} + \frac{w ( {M}_{2} )}{{T}_{g} ( {M}_{2} )}$$

wherein T_{g}(calc.) is the glass transition temperature calculated for the copolymer, w(M₁) is the weight fraction of monomer M₁ in the copolymer, w(M₂) is the weight fraction of monomer M₂ in the copolymer, T_{g}(M₁) is the glass transition temperature of the homopolymer of monomer M₁, and T_{g}(M₂) is the glass transition temperature of the homopolymer of monomer M₂, all temperatures being in K. The glass transition temperatures of the homopolymers may be found, for example, in “Polymer Handbook”, edited by J. Brandrup and E.H. Immergut, Interscience Publishers.

“Weight of the emulsion polymer” refers to the dry weight of the emulsion polymer.

The aqueous coating composition of the present invention comprises one or more emulsion polymers (component (A)), typically in an aqueous dispersion. The emulsion polymer comprises structural units of one or more ethylenically unsaturated phosphorous-containing monomers (monomer (i)). The ethylenically unsaturated phosphorous-containing monomers can be dihydrogen phosphate esters of an alcohol in which the alcohol contains or is substituted with a polymerizable vinyl or olefinic group. The ethylenically unsaturated phosphorous-containing monomer may include phosphoalkyl (meth)acrylates such as phosphoethyl (meth)acrylate, phosphopropyl (meth)acrylate, phosphobutyl (meth)acrylate, salts thereof, and mixtures thereof; CH₂═C(Rₚ₁)—C(O)—O—(Rₚ₂O)_{q}—P(O)(OH)₂, wherein Rₚ₁=H or CH₃, Rₚ₂=alkylene, such as an ethylene group, a propylene group, or a combination thereof; and q=1-20, such as SIPOMER PAM-100, SIPOMER PAM-200, SIPOMER PAM-300 and SIPOMER PAM-600 all available from Solvay; phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho di-propylene glycol (meth)acrylate, phospho tri-propylene glycol (meth)acrylate, salts thereof, or mixtures thereof. Desirably, the phosphorus acid monomer is selected from phosphoethyl methacrylate (PEM), phosphoethyl acrylate, allyl ether phosphate, phosphopropyl methacrylate, phosphobutyl methacrylate, or mixtures thereof; and more desirably, phosphoethyl methacrylate. The emulsion polymer may comprise structural units of monomer (i) the ethylenically unsaturated phosphorous-containing monomer at a concentration of from 0.48% to 1.5%, and can be 0.48% or more, 0.50% or more, 0.52% or more, 0.55% or more, 0.58% or more, 0.60% or more, 0.62% or more, 0.65% or more, 0.68% or more, 0.70% or more, 0.72% or more, 0.75% or more, 0.78% or more, 0.80% or more, 0.82% or more, 0.85% or more, 0.88% or more even 0.90° % or more while at the same time is generally 1.5% or less, and can be 1.4% or less, 1.3% or less, 1.20% or less, 1.19% or less, 1.18% or less, 1.17% or less, 1.16% or less, 1.15% or less, 1.12% or less, 1.10% or less, 1.08% or less, 1.05% or less, 1.02% or less, 1.00% or less, 0.98% or less, 0.95% or less, or even 0.92% or less, and desirably, 0.63% to 1.2% or 0.8% to 1.2%, by weight based on the weight of the emulsion polymer.

The emulsion polymer useful in the present invention may comprise structural units of diacetone (meth)acrylamide (monomer (ii)), and desirably, diacetone acrylamide (DAAM). The emulsion polymer may comprise structural units of monomer (ii) the diacetone (meth)acrylamide at a concentration of from 0.7% to 3%, and can be 0.7% or more, 0.75% or more, 0.8% or more, 0.9% or more, 1.0% or more, 1.1% or more, 1.2% or more, 1.3% or more, 1.4% or more, 1.5% or more, 1.6% or more, 1.7% or more, even 1.75% or more while at the same time is generally at a concentration of 3% or less, and can be 2.9% or less, 2.8% or less, 2.7% or less, 2.6% or less, 2.5% or less, 2.45% or less, 2.3% or less, 2.2% or less, 2.1% or less, 2.00% or less, 1.9% or less, 1.8% or less, or even 1.75% or less, and desirably, 1.75% to 2.45% or 1.1% to 2.1%, by weight based on the weight of the emulsion polymer.

The emulsion polymer useful in the present invention may comprise structural units of one or more vinyl aromatic monomers (monomer (iii)). Suitable vinyl aromatic monomers may include, for example, styrene and substituted styrene such as .alpha.-methyl styrene, p-methyl styrene, t-butyl styrene, trans-beta-methylstyrene, 2,4-dimethylstyrene, ethylstyrene, o-, m-, and p-methoxystyrene; p-trifluoromethylstyrene, or mixtures thereof. Desirably, the vinyl aromatic monomer is styrene. The emulsion polymer may comprise structural units of monomer (iii) the vinyl aromatic monomer at a concentration of from 10% to 80%, and can be 10% or more, 20% or more, 30% or more, 35% or more, 40% or more, 45% or more, 50% or more, even 55% or more while at the same time is generally at a concentration of 80% or less, and can be 75% or less, 70% or less, 65% or less, or even 60% or less, and desirably, 40% to 65%, by weight based on the weight of the emulsion polymer.

The emulsion polymer useful in the present invention may comprise structural units of one or more alkyl (meth)acrylates containing alkyl with from 1 to 24 carbon atoms (monomer (iv)) that are other than the monomer (i) above. The alkyl (meth)acrylates may have from 1 to 20 carbon atoms, 4 to 10 carbon atoms, or 4 to 8 carbon atoms. The alkyl group can be a linear, branched or cyclic alkyl, and desirably, a linear or branched alkyl. Examples of suitable alkyl (meth)acrylates include methyl (meth)acrylate, ethyl (meth)acrylate, 2-ethylhexyl (meth)acrylate, butyl (meth)acrylate, tert-butyl (meth)acrylate, lauryl (meth)acrylate, stearyl (meth)methacrylate, dibutyl itaconate, diethyl itaconate, cycloalkyl (meth)acrylates such as cyclohexyl acrylate, cyclohexyl methacrylate, methylcyclohexyl (meth)acrylate, isobornyl methacrylate, isobornyl acrylate, dihydrodicyclopentadienyl (meth)acrylate, trimethylcyclohexyl (meth)acrylate, or t-butyl (meth)cyclohexyl acrylate; mixtures thereof; or combinations thereof. Desirably, the alkyl (meth)acrylate is selected from butyl acrylate, 2-ethylhexyl (meth)acrylate, ethyl (meth)acrylate, or mixtures thereof. The total concentration of structural units of the alkyl (meth)acrylate may be in a range of from 10% to 70%, and can be 10% or more, 15% or more, 20% or more, 25% or more, 30% or more, 35% or more, even 40% or more while at the same time is generally at a concentration of 70% or less, and can be 65% or less, 60% or less, 55% or less, 50% or less, 45% or less, or even 40% or less, and desirably, 30% to 55%, by weight based on the weight of the emulsion polymer. Desirably, the emulsion polymer may comprise or be free of structural units of the cycloalkyl (meth)acrylate. The concentration of the structural units of the cycloalkyl (meth)acrylate in the emulsion polymer may be in a range of from zero to 5%, and can be less than 5%, less than 4%, less than 3%, less than 2%, less than 1%, or even zero, by weight based on the weight of the emulsion polymer.

The emulsion polymer useful in the present invention may comprise or be free of structural units of one or more α, β-ethylenically unsaturated carboxylic acids, salts thereof, or mixtures thereof (monomer (v)). Suitable α, β-ethylenically unsaturated carboxylic acids may include, for example, acrylic acid, methacrylic acid, maleic acid, itaconic acid, crotonic acid, fumaric acid, 2-carboxyethyl acrylate, or mixtures thereof. The α, β-ethylenically unsaturated carboxylic acids also include monomers bearing an acid-forming group which yields or is subsequently convertible to, such an acid group (such as anhydride, (meth)acrylic anhydride, or maleic anhydride); or mixtures thereof. Desirably, the α, β-ethylenically unsaturated carboxylic acid is selected from acrylic acid, methacrylic acid, itaconic acid, 2-carboxyethyl acrylate, or mixtures thereof. The emulsion polymer may comprise structural units of monomer (v) the α, β-ethylenically unsaturated carboxylic acid and salt thereof at a concentration of from zero to 5%, and can be zero or more, 0.3% or more, 0.5% or more, 0.8% or more, 1.0% or more, 1.2% or more, 1.5% or more, 1.8% or more, even 2% or more while at the same time is generally at a concentration of 5% or less, and can be 4.5% or less, 4% or less, 3.5% or less, 3.2% or less, 2.8% or less, 3.0% or less, 2.8% or less, 2.5% or less, 2.2% or less, or even 2.0% or less, and desirably, 0.3% to 4% or 1.75% to 2.5%, by weight based on the weight of the emulsion polymer.

The emulsion polymer useful in the present invention may comprise or be free of structural units of one or more monoethylenically unsaturated functional monomers that are other than the monomers (i)-(v) described above, having one or more functional groups selected from amide, silane, hydroxyl, ureido, imide, glycidyl, amino, and sulfonic acid; salts thereof; or combinations thereof (monomer (vi)). These monoethylenically unsaturated functional monomers may include, for example, amino-functional monomers such as dimethylaminoethyl methacrylate, dimethylaminoethyl acrylate, dimethylaminopropyl methacrylate, dimethylaminopropyl acrylate, or mixtures thereof; monomers bearing amide-functional groups such as acrylamide and methacrylamide; monomers bearing glycidyl-functional groups such as glycidyl acrylate, glycidyl methacrylate, or mixtures thereof; vinyltrialkoxysilanes such as vinyltrimethoxysilane, vinyltriethoxysilane, vinyltris(2-methoxyethoxy)silane, vinyldimethylethoxysilane, vinylmethyldiethoxysilane, or mixtures thereof; (meth)acryloxyalkyltrialkoxysilanes such as (meth)acryloxyethyltrimethoxysilane, (meth)acryloxypropyltrimethoxysilane, or mixtures thereof; ureido-functional monomers; hydroxyl-functional monomers such as 2-hydroxyethyl acrylate, 2-hydroxyethyl methacrylate, 2-hydroxypropyl methacrylate, 3-hydroxybutyl methacrylate, or mixtures thereof; ethylenically unsaturated compounds comprising a cyclic ureido group (i.e., an imidazolidin-2-one group) including cyclic-ureido-group-containing alkyl esters of (meth)acrylic acids such as N-(2-methacrylamidoethyl)ethylene urea, N-(2-methacryloyloxyethyl) ethylene urea, N-(maleate diethyl) ethylene urea, or mixtures thereof; sulfonic acid monomers including sodium vinyl sulfonate (SVS), sodium styrene sulfonate (SSS) and acrylamido-methyl-propane sulfonate (AMPS), salts thereof, or mixtures thereof; and combinations thereof. Desirably, the monomer (vi) is N-(2-methacryloyloxyethyl) ethylene urea. The emulsion polymer may comprise structural units of monomer (vi) the monoethylenically unsaturated functional monomer at a concentration of zero to 5%, and can be zero or more, 0.05% or more, 0.1% or more, 0.2% or more, 0.3% or more, 0.4% or more, even 0.5% or more while at the same time is generally at a concentration of 5% or less, and can be 4% or less, 3.5% or less, 3% or less, 2.5% or less, 2% or less, 1.5% or less, 1% or less, 0.8% or less, or even 0.6% or less, and desirably, 0.1% to 1%, by weight based on the weight of the emulsion polymer.

The emulsion polymer useful in the present invention may comprise or be free of structural units of one or more multiethylenically unsaturated monomers (monomer (vii)). Examples of suitable multiethylenically unsaturated monomers include alkylene glycol diacrylates and dimethacrylates such as ethylene glycol di(meth)acrylate; 1,1,1-trimethylol propane di(meth)acrylate; pentaerythritol trimethacrylate; vinyl (meth)acrylate; divinyl benzene; allyl (meth)acrylate; allyl (meth)acrylamide; allyl oxyethyl (meth)acrylate, crotyl (meth)acrylate, dicyclopentenyl (meth)acrylate, dicyclopentenyl ethyl (meth)acrylate; diallyl maleate; or mixtures thereof. The emulsion polymer may comprise structural units of monomer (vii) the multiethylenically unsaturated monomer at a concentration of from zero to 1%, and can be 0.05% or more, 0.1% or more, even 0.15% or more while at the same time is generally at a concentration of 1% or less, and can be less than 1%, 0.8% or less, 0.5% or less, 0.4% or less, or even 0.3% or less, by weight based on the weight of the emulsion polymer.

The emulsion polymer useful in the present invention may comprise or be free of structural units of one or more monoethylenically unsaturated benzophenones, monoethylenically unsaturated acetophenones, or mixtures thereof (monomer (viii)). Suitable monoethylenically unsaturated benzophenones may include, for example, vinyl benzophenone, (2-hydroxy-3-methacryloxy) propyl ortho-benzoyl-benzoate, (2-hydroxy-3-acryloxy) propyl ortho-benzoyl-benzoate, or mixtures thereof. The structural units of monomer (viii) the monoethylenically unsaturated benzophenone, the monoethylenically unsaturated acetophenone, or mixtures thereof may be present at a total concentration of from zero to 3%, and can be zero or more, 0.1% or more, 0.3% or more, 0.5% or more, even 0.7% or more while at the same time is generally at a concentration of 3.0% or less, and can be 2.0% or less, 1.5% or less, 1.2% or less, 1.0% or less, or even 0.9% or less, and desirably, zero to 1%, by weight based on the weight of the emulsion polymer.

Desirably, the emulsion polymer useful in the present invention comprises, by weight based on the weight of the emulsion polymer, from 0.8% to 1.2% of structural units of phosphoethyl methacrylate; from 1.1% to 2.1% of structural units of diacetone acrylamide; from 40% to 65% of structural units of styrene; from 30% to 55% of structural units of butyl acrylate, 2-ethylhexyl acrylate, butyl methacrylate, or mixtures thereof; and from 0.3% to 4% of structural units of acrylic acid, methacrylic acid, or mixtures thereof.

The emulsion polymer can be a one-stage polymer or a multistage polymer. Desirably, the emulsion polymer is a multistage polymer such as a two-stage polymer, comprising a polymer A and a polymer B. “One-stage polymer” herein refers to an emulsion polymer prepared by one-stage emulsion polymerization. “Multistage polymer” herein refers to an emulsion polymer prepared by multistage emulsion polymerization of two or more different monomer compositions sequentially added in different stages such as in the first stage and in the second stage, thereby forming at least a polymer A and a polymer B. By “polymer A” and “polymer B” mean these polymers having different compositions and formed in different stages of multistage emulsion polymerization, and desirably, the polymer A is in the first stage and the polymer B in the second stage of the multistage emulsion polymerization. Each of the stages is sequentially polymerized and different from the immediately proceeding and/or immediately subsequent stage by a difference in monomer composition. Without being bounded by a theory, the multistage polymer may comprise multiple different phases or layers, which can be demonstrated by scanning transmission electron microscope (STEM) or at least two Tgs as measured by differential scanning calorimetry (DSC). Desirably, the polymer A is the outer layer and the polymer B is the inner layer, of the multistage polymer. The multistage polymer may consist of the polymer A and the polymer B. The types and concentrations of structural units of the monomers described above in the emulsion polymer section may be chosen to be in the polymer A and/or the polymer B so as to provide the resulting multistage polymer (i.e., the emulsion polymer) with the values of Tg described above in the emulsion polymer section. Desirably, the polymer A has a Tg of less than 20° C., and can be 17° C. or less, 14° C. or less, 11° C. or less, even 8° C. or less while at the same time is generally −20° C. or more, and can be −15° C. or more, −10° C. or more, −5° C. or more, 0° C. or more, 4° C. or more, or even 6° C. or more. The polymer B may have a Tg of higher than 30° C., and can be 35° C. or more, 40° C. or more, 45° C. or more, 49° C. or more, even 52° C. or more while at the same time is generally less than 80° C., and can be 75° C. or less, 70° C. or less, 65° C. or less, 60° C. or less, 57° C. or less, or even 54° C. or less. The values of Tg are calculated by the Fox equation.

When the emulsion polymer is a multistage polymer, structural units of the monomers described above in the emulsion polymer section can be present in one of or both of the polymer A and the polymer B at certain concentrations so that the total concentration of structural units of each monomer relative to the weight of the multistage polymer (i.e., the emulsion polymer weight) is the same as the weight concentration of structural units of such monomer relative to the emulsion polymer weight described above. For example, one or both of the polymer A and the polymer B in the multistage polymer comprises structural units of monomer (iv) the alkyl (meth)acrylate. The polymer A and/or the polymer B, and desirably, the polymer A, may comprise or be free of structural units of monomer (v) the α, β-ethylenically unsaturated carboxylic acid, the salt thereof, or mixtures thereof. For example, the polymer A may comprise from 1% to 7% by weight based on the weight of the polymer A, of structural units of monomer (v); and the polymer B may comprise from zero to 3% by weight based on the weight of the polymer B, of structural units of monomer (v). The polymer A and/or the polymer B may comprise or be free of structural units of one or more of monomers (vi), (vii), and (viii) described above. Desirably, the multistage polymer comprises from 50% to 90% by weight of the polymer A and from 10% to 50% by weight of the polymer B, based on the weight of the multistage polymer (i.e., the emulsion polymer weight), where the polymer A comprises, by weight based on the weight of the polymer A, from 0.3% to 2.4% of structural units of monomer (i) the ethylenically unsaturated phosphorous-containing monomer, from 1% to 6% of structural units of monomer (ii) the diacetone (meth)acrylamide, from 10% to 75% of structural units of monomer (iii) the vinyl aromatic monomer, where the polymer B comprises, by weight based on the weight of the polymer B, from zero to 2.5% of structural units of monomer (i) the ethylenically unsaturated phosphorous-containing monomer; from zero to 2.5% of structural units of monomer (ii) the diacetone (meth)acrylamide, and from 10% to 100% of structural units of monomer (iii) the vinyl aromatic monomer, and where at least one of (and desirably both of) the polymer A and polymer B further comprises structural units of monomer (iv) the alkyl (meth)acrylate. All monomers (i)-(v) are described as above in the emulsion polymer section.

One or both of the polymer A and the polymer B (desirably, the polymer A) in the multistage polymer may comprise structural units of the ethylenically unsaturated phosphorous-containing monomer. The polymer A may comprise structural units of monomer (i) the ethylenically unsaturated phosphorous-containing monomer at a concentration of from 0.3% to 2.4%, and can be 0.3% or more, 0.5% or more, 0.6% or more, 0.7% or more, 0.8% or more, 0.9% or more, 1.0% or more, 1.1% or more, 1.2% or more, 1.3% or more, 1.4% or more, 1.5% or more, even 1.6% or more while at the same time is generally at a concentration of 2.4% or less, and can be 2.3% or less, 2.2% or less, 2.1% or less, 2.0% or less, 1.9% or less, 1.8% or less, or even 1.7% or less, and desirably, 0.9% to 1.8%, by weight based on the weight of the polymer A. The polymer B may comprise or be free of structural units of monomer (i) the ethylenically unsaturated phosphorous-containing monomer, at a concentration of from zero to 2.5%, and can be zero or more, 0.1% or more, 0.2% or more, 0.3% or more, 0.4% or more, even 0.5% or more while at the same time is generally at a concentration of 2.5% or less, and can be 2.2% or less, 2.0% or less, 1.8% or less, 1.5% or less, 1.2% or less, 1.0%, or less, 0.9% or less, or even 0.6% or less, and desirably, zero to 1.0%, by weight based on the weight of the polymer B.

One or both of the polymer A and the polymer (desirably, the polymer A) in the multistage polymer may comprise structural units of the diacetone (meth)acrylamide. The polymer A may comprise structural units of monomer (ii) the diacetone (meth)acrylamide at a concentration of from 1.0% to 6.0%, and can be 1.0% or more, 1.2% or more, 1.5% or more, 1.8% or more, 2.0% or more, 2.2% or more, 2.5% or more, 2.8% or more, even 3% or more while at the same time is generally at a concentration of 6.0% or less, and can be 5.5% or less, 5.2% or less, 5% or less, 4.8% or less, 4.5% or less, 4.2% or less, 4% or less, 3.8% or less, 3.6% or less, 3.5% or less, or even 3.2% or less, and desirably, 1.5% to 4% or 2.0% to 3.5%, by weight based on the weight of the polymer A. The polymer B may comprise structural units of monomer (ii) the diacetone (meth)acrylamide at a concentration of from zero to 2.5%, and can be zero or more, 0.1% or more, 0.2% or more, 0.3% or more, 0.4% or more, even 0.5% or more while at the same time is generally at a concentration of 2.5% or less, and can be 2.2% or less, 2.0% or less, 1.5% or less, 1.0% or less, or even 0.6% or less, and desirably, zero to 1.5% or 0.5% to 1.0%, by weight based on the weight of the polymer B.

One or both of the polymer A and the polymer B in the multistage polymer may comprise structural units of the vinyl aromatic monomer. The polymer A may comprise structural units of monomer (iii) the vinyl aromatic monomer at a concentration of from 10% to 75%, and can be 10% or more, 15% or more, 20% or more, 25% or more, 30% or more, 35% or more, 40% or more, 45% or more, even 50% or more while at the same time is generally at a concentration of 75% or less, and can be 70% or less, 65% or less, 60% or less, or even 55% or less, and desirably, 30% to 55%, by weight based on the weight of the polymer A. The polymer B may comprise structural units of monomer (iii) the vinyl aromatic monomer at a concentration of from 10% to 100%, and can be 10% or more, 25% or more, 30% or more, 40% or more, 50% or more, 60% or more, even 70% or more while at the same time is generally at a concentration of 100% or less, and can be 95% or less, 90% or less, 85% or less, or even 80% or less, and desirably, 50% to 85%, by weight based on the weight of the polymer B.

The polymer A may be present in the multistage polymer at a concentration of 50% to 90%, and can be 52% to 78%, 55% to 75%, 58% to 74%, 60% to 72%, 62% to 71%, or 65% to 70%, by weight based on the weight of the multistage polymer. The polymer B may be present in the multistage polymer at a concentration of 10% to 50%, and can be 22% to 48%, 25% to 45%, 26% to 42%, 28% to 40%, 29% to 38%, or 30% to 35%, by weight based on the weight of the multistage polymer. Desirably, the multistage polymer comprises from 55% to 85% of the polymer A and from 15% to 45% of the polymer B, by weight based on the weight of the multistage polymer.

The emulsion polymer useful in the present invention may have a number average molecular weight (Mn) of 8,000 grams per mole (g/mol) to 60,000 g/mol, and can be 8,000 g/mol or more, 10,000 g/mol or more, 11,000 g/mol or more, 12,000 g/mol or more, 14,000 g/mol or more, 15,000 g/mol or more, 17,000 g/mol or more, 18,000 g/mol or more, 20,000 g/mol or more, 22,000 g/mol or more, 24,000 g/mol or more, even 26,000 g/mol or more while at the same time is generally 60,000 g/mol or less, 55,000 g/mol or less, 50,000 g/mol or less, 45,000 g/mol or less, 40,000 g/mol or less, 38,000 g/mol or less, 35,000 g/mol or less, 32,000 g/mol or less, 30,000 g/mol or less, 29,000 g/mol or less, 28,000 g/mol or less, 27,000 g/mol or less, or even 26,000 g/mol or less, and desirably, 10,000 g/mol to 30,000 g/mol. Molecular weight of the emulsion polymer may be measured by Gel Permeation Chromatography (GPC) (further details provided under GPC Analysis below).

Types and levels of the monomers above for preparing the emulsion polymer may be chosen to provide the emulsion polymer with a glass transition temperature (Tg) suitable for various applications. The Tg of the emulsion polymer may be −10 degrees Celsius (° C.) or higher, and can be −5° C. or higher, 0° C. or higher, 5° C. or higher, 10° C. or higher, even 15° C. or higher while at the same time is generally 50° C. or less, and can be 45° C. or less, 40° C. or less, 35° C. or less, 30° C. or less, 25° C. or less, or even 20° C. or less, as calculated by the Fox equation.

Total concentration of structural units of monomers described above (e.g., monomers (i)-(iv), and optionally monomers (v)-(viii) if present) in the emulsion polymer, by weight based on the weight of the emulsion polymer, is equal to 100%. When the emulsion polymer is the multistage polymer, the total concentration of structual units of monomers described above in both the polymer A and polymer B can be equal to 100% by weight relative to the multistage polymer weight (i.e., the emulsion polymer weight). Structural units of monomers in the polymer A and polymer B, respectively, add to 100% by weight based on the weight of the polymer A and the polymer B, respectively.

The emulsion polymer useful in the present invention may be prepared by emulsion polymerization of a monomer mixture comprising the monomers described above (e.g., monomers (i)-(iv), and optionally monomers (v)-(viii) if present). Total concentration of the monomers in the monomer mixture for preparing the emulsion polymer, by weight based on the total weight of the monomer mixture, is equal to 100%. For each monomer, the weight concentration of a monomer in the monomer mixture relative to the total weight of the monomer mixture is the same as the above described weight concentration of structural units of such monomer in the emulsion polymer relative to the weight of the emulsion polymer. The monomer mixture may be added neat or as an emulsion in water; or added in one or more additions or continuously, linearly or nonlinearly, over the reaction period of preparing the emulsion polymer. Temperature suitable for emulsion polymerization process may be lower than 100° C., and can be in a range of from 10 to 99° C. or from 50 to 90° C. One or more surfactants may be used in preparing the emulsion polymer. The emulsion polymer can be prepared by one-stage emulsion polymerization, or a multistage emulsion polymerization process, thereby forming the multistage polymer. The multistage emulsion polymerization process includes at least two stages are formed sequentially, which usually results in the formation of the multistage polymer comprising at least the polymer A and the polymer B, optionally the different stages can be formed in different reactors. Desirably, the multistage emulsion polymerization process comprises a stage of preparing the polymer A in an aqueous medium (desirably, the first stage) and a stage of preparing the polymer B (desirably, the second stage); both by emulsion polymerization. The process may include a stage of polymerization of a monomer mixture A to form the polymer A and a stage of polymerization of a monomer mixture B to form the polymer B. Desirably, the process for preparing the multistage polymer includes the stage of polymerization to form the polymer A first, and optionally neutralized the polymer A, subsequent the stage of polymerization to form the polymer B in the presence of the polymer A. The monomer mixtures A and B may each independently include the monomers described above (e.g., monomers (i)-(viii) if present) for forming the structural unis of the polymers A and B, respectively. Total concentration of the monomer mixtures for preparing the polymer A and the polymer B relative to total weight of monomers for preparing the multistage polymer can be equal to 100%, relative to the weight of the multistage polymer (e.g., the total weight of the polymer A and the polymer B). For each monomer, the concentration of the monomer relative to the total weight of monomers used in preparing a polymer (e.g., polymer A) is substantially the same as the concentration of structural units of such monomer relative to the total weight of such polymer (e.g., polymer A).

One or more radical initiators may be used in the polymerization process. The polymerization process may be thermally initiated or redox initiated emulsion polymerization. Examples of suitable free radical initiators include hydrogen peroxide, t-butyl hydroperoxide, cumene hydroperoxide, ammonium and/or alkali metal persulfates, sodium perborate, perphosphoric acid, and salts thereof; potassium permanganate, and ammonium or alkali metal salts of peroxydisulfuric acid. The free radical initiators may be used typically at a level of 0.01% to 3.0% by weight, based on the total weight of monomers. Redox systems comprising the above described initiators coupled with a suitable reductant may be used in the polymerization process. Examples of suitable reductants include sodium sulfoxylate formaldehyde, ascorbic acid, isoascorbic acid, alkali metal and ammonium salts of sulfur-containing acids, such as sodium sulfite, bisulfite, thiosulfate, hydrosulfite, sulfide, hydrosulfide or dithionite, formadinesulfinic acid, acetone bisulfite, glycolic acid, hydroxymethanesulfonic acid, glyoxylic acid hydrate, lactic acid, glyceric acid, malic acid, tartaric acid and salts of the proceeding acids. Metal salts of iron, copper, manganese, silver, platinum, vanadium, nickel, chromium, palladium, or cobalt may be used to catalyze the redox reaction. Chelating agents for the metals may optionally be used.

One or more surfactants may be used in the polymerization process for preparing the emulsion polymer. The surfactant may be added prior to or during the polymerization of the monomers, or combinations thereof. A portion of the surfactant can also be added after the polymerization. Surfactants may be used for at least one stage or all stages of preparing the multistage polymer. The surfactants may include anionic and/or nonionic emulsifiers. The surfactants can be reactive surfactants such as polymerizable surfactants. Examples of suitable surfactants include alkali metal or ammonium salts of alkyl, aryl, or alkylaryl sulfates, sulfonates or phosphates; alkyl sulfonic acids; sulfosuccinate salts; fatty acids; and ethoxylated alcohols or phenols. Desirably, the alkali metal or ammonium salts of alkyl, aryl, or alkylaryl sulfates surfactant are used. The combined amount of the surfactant used is usually from zero to 10% or from 0.5% to 3%, by weight based on the weight of total monomers (that is, the monomer mixture) used for preparing the emulsion polymer.

One or more chain transfer agents may be used in the polymerization process to control the molecular weight of the emulsion polymer. When the emulsion polymer is prepared by multistage polymerization (i.e., the multistage polymer), the chain transfer agent may be used in the stage of preparing the polymer A, in the stage of preparing the polymer B, or in both stages. Examples of suitable chain transfer agents include 3-mercaptopropionic acid, methyl 3-mercaptopropionate, butyl 3-mercaptopropionate, n-dodecyl mercaptan, n-hexadecanethiol, tert-dodecyl mercaptan, n-octadecanethiol, benzenethiol, azelaic alkyl mercaptan, hydroxy group containing mercaptans such as hydroxyethyl mercaptan, mercaptopropionic acid, and mixtures thereof. The chain transfer agent may be used at a concentration of from zero to 2%, and can be zero or more, 0.05% or more, 0.1% or more, even 0.15% or more while at the same time is generally at a concentration of 2% or less, and can be 1.5% or less, 1.0% or less, 0.5% or less, 0.3% or less, 0.25% or less, or even 0.20% or less, by weight based on the total weight of the monomers used for preparing the emulsion polymer.

After completing the polymerization, the obtained aqueous dispersion (i.e., polymer emulsion) may be neutralized by one or more bases as neutralizers to a pH value, for example, at least 5, from 6 to 12, from 7 to 10, or from 8 to 9. The bases may lead to partial or complete neutralization of the ionic or latently ionic groups of the emulsion polymer. Examples of suitable bases include ammonia; alkali metal or alkaline earth metal compounds such as sodium hydroxide, potassium hydroxide, calcium hydroxide, sodium carbonate; primary, secondary, and tertiary amines, such as triethyl amine, ethylamine, propylamine, monoisopropylamine, monobutylamine, hexylamine, ethanolamine, diethyl amine, dimethyl amine, tributylamine, triethanolamine, dimethoxyethylamine, 2-ethoxyethylamine, 3-ethoxypropylamine, dimethylethanolamine, diisopropanolamine, morpholine, ethylenediamine, 2-diethylaminoethylamine, 2,3-diaminopropane, 1,2-propylenediamine, neopentanediamine, dimethylaminopropylamine, hexamethylenediamine, 4,9-dioxadodecane-1,12-diamine, polyethyleneimine or polyvinylamine; aluminum hydroxide; or mixtures thereof.

The emulsion polymer particles in the aqueous composition may have a particle size of 40 nanometers (nm) to 500 nm, and can be 60 nm or more, 80 nm or more, 90 nm or more, 100 nm or more, greater than 100 nm, 105 nm or more, even 110 nm or more while at the same time is 500 nm or less, and can be 300 nm or less, 200 nm or less, or even 150 nm or less. The particle size herein refers to Z-average size and may be measured by a Brookhaven BI-90 Plus Particle Size Analyzer.

The aqueous coating composition of the present invention may comprise the emulsion polymer at a concentration of 1% to 30%, and can be 1% or more, 2% or more, 3% or more, 4% or more, even 5% or more while at the same time is generally at a concentration of 30% or less, and can be 25% or less, 20% or less, 15% or less, or even 10% or less, by weight based on the weight of the aqueous coating composition.

The aqueous coating composition of the present invention may further comprise one or more polyfunctional carboxylic hydrazides containing at least two hydrazide groups per molecule. The polyfunctional carboxylic hydrazide may be selected from adipic dihydrazide, oxalic dihydrazide, isophthalic dihydrazide, polyacrylic polyhydrazides, or mixtures thereof. The polyfunctional carboxylic hydrazide may be present at a concentration of zero or more, and can be 0.05% or more, 0.1% or more, 0.2% or more, 0.4% or more, even 0.6% or more while at the same time is typically at a concentration of 3% or less, and can be 2% or less, 1.5% or less, or even 1% or less, by weight based on the weight of the emulsion polymer.

The aqueous coating composition of the present invention comprises one or more dicarboxylic acids, salts thereof, or mixtures thereof (component (B)), typically in the form of an aqueous solution. “Dicarboxylic acid” refers to a compound containing two carboxyl functional groups (—COOH). The dicarboxylic acid useful in the present invention may have the structure of formula (I):

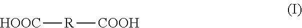

where R is an alkylene, alkenylene, alkynylene, cycloalkylene, cycloalkenylene, cycloalkynylene, arylene, or heterocyclic arylene group; containing 6 to 18 carbon atoms (C₆-C₁₈). R can contain 6 to 18 carbon atoms, and can have 7 carbon atoms or more, 8 carbon atoms or more, 9 carbon atoms or more, even 10 carbon atoms or more while at the same time generally has 18 carbon atoms or less, and can be 17 carbon atoms or less, 16 carbon atoms or less, 15 carbon atoms or less, or even 14 carbon atoms or less. Desirably, the dicarboxylic acid is a linear (i.e., unbranched) or branched aliphatic dicarboxylic acid. Desirably, R is a C₆-C₁₈ alkylene group (i.e., —(CH₂)ₙ—, where n=6-18), and more desirably, a C₆-C₁₈ alkylene group. Desirably, the dicarboxylic acid is a saturated dicarboxylic acid. The aqueous coating composition may comprise a mixture of two or more dicarboxylic acids different in R groups, a mixture of salts of two or more different dicarboxylic acids, or combinations thereof.

Suitable dicarboxylic acids may include, for example, sebacic acid (HOOC(CH₂)₈COOH), dodecanedioic acid (HOOC(CH₂)₁₀COOH), suberic acid (HOOC(CH₂)(COOH), anchoic acid (HOOC(CH₂)₇COOH), undecanedioic acid (HOOC(CH₂)₉COOH), eicosanedioic acid (HOOC(CH₂)₁₈RCOOH), or mixtures thereof; and desirably, sebacic acid.

The aqueous coating composition typically comprises a reaction mixture of at least one dicarboxylic acid (desirably, sebacic acid) with at least one base. The bases useful for neutralizing (i.e., reacting with) the dicarboxylic acid may include those bases described above for neutralizing the aqueous dispersion of the emulsion polymer section, particularly, ammonia, N, N-dimethyl ethanol amine, 2-amino-2-methyl-1-propanol, or mixtures thereof. The base used to neutralize the dicarboxylic acid to form a salt of the dicarboxylic acid (also as “dicarboxylic acid salt”) may be in an amount to provide a dry weight ratio of the base to the dicarboxylic acid in a range of 30:70 to 70:30, and can be 35:65 to 65:35, 40:60 to 60:40, or 45:55 to 55:45. The aqueous coating composition typically comprise one or more salts of the dicarboxylic acids. Depending on the type of the base used, the resulting salts of dicarboxylic acids can be ammonium salts, alkali metal salts, amine salts, or mixtures thereof. These salts can be mono-neutralized salts of the dicarboxylic acid, bis-neutralized salts of dicarboxylic acid, or mixtures thereof.

Component (B) the dicarboxylic acid and/or salt thereof may be present in an amount to provide —OOC—R—COO— segments in the aqueous coating composition at a concentration of from 1.1% to 3.8%, and can be 1.1% or more, 1.2% or more, 1.5% or more, even 1.8% or more while at the same time is generally 3.8% or less, and can be 3.5% or less, 3.2% or less, 3.0% or less, 2.8% or less, 2.5% or less, or even 2.0% or less, and desirably, 1.1% to 2.0%, by weight based on the weight of the emulsion polymer. The —OOC—R—COO— segments may result from the dicarboxylic acid and/or the salts of the dicarboxylic acid. The concentration of the —OOC—R—COO— segments can be determined by liquid chromatography-mass spectrometry (LC-MS), nuclear magnetic resonance (NMR), and/or extraction analyses. Alternatively, the concentration of the —OOC—R—COO— segments can be calculated by the weight of original added, non-neutralized dicarboxylic acid, relative to the weight of the aqueous coating composition. In the case of the aqueous coating composition comprising the salts of a dicarboxylic acid, the weight of the dicarboxylic acid used for forming such salts, instead of the weight of the salts, is used for calculating the concentration of the —OOC—R—COO— segments.

The aqueous coating composition of the present invention comprises one or more thio-, amido-, or imido-derivatives of triphosphonic acids, salts thereof, or mixtures thereof (component (C), also referred to as “triphosphonic acid derivative”). The triphosphonic acid derivative may be selected from tri(thio)phosphonic acids, trihypophosphonic acids, (thio)imido-triphosphonic acids, or (thio)hydrazido-triphosphonic acids; salts thereof; or combinations thereof. Desirably, the triphosphonic acid derivative is selected from amino trimethylene phosphonic acid (ATMP) and amino triethylene phosphonic acid; salts thereof; or combinations thereof. The aqueous coating composition may comprise a mixture of two or more thio-, amido-, or imido-derivatives of triphosphonic acids, a mixture of salts thereof, or combinations thereof. The concentration of component (C) the triphosphonic acid derivative may be in a range of from 30% to 60%, and can be 30% or more, 31% or more, 32% or more, 33% or more, 34% or more, even 35% or more while at the same time is generally 60% or less, and can be 58% or less, 56% or less, 55% or less, 52% or less, 50% or less, 45% or less, 40% or less, or even 38% or less, and desirably, 35% to 50%, by weight based on the weight of the emulsion polymer.

The aqueous coating composition of the present invention may comprise a water-soluble alkali metal silicates (component (D)). Alkali metal silicates can be sodium silicates, potassium silicates, lithium silicates, or combinations thereof. Suitable alkali metal silicates can be any silicate of the general formula of M₂O·xSiO₂, where M represents an alkali metal, including lithium, sodium, potassium, and combinations thereof; and x represents the molar ratio of silica (SiO₂) to metal oxide (M₂O). Sodium silicates (Na₂O·xSiO₂) usually have the molar ratio of Na₂O to SiO₂ in a range of 1:4 to 2:1. Potassium silicates (K₂O·xSiO₂) usually have the molar ratio of K₂O to SiO₂ between 0.2 to 1. Lithium silicates (Li₂O·xSiO₂) typically have the molar ratio of Li₂O to SiO₂ between 0.3 and 8. Mixed water-soluble alkali metal silicates, such as potassium sodium silicate, lithium potassium silicate, or mixtures thereof, can be used. Potassium silicates including all variable compositions between and including K₂Si₂O, to K₂Si₃O₇ can be used. Desirably, the water-soluble silicate is a sodium silicate. Suitable sodium silicates may include, for example, sodium orthosilicate (Na₄SiO₄), sodium metasilicate (Na₂SiO₃), sodium disilicate (Na₂Si₂O₅), sodium tetrasilicate (Na₂Si₄O₉), sodium pyrosilicate (Na₆Si₂O₇), other sodium polysilicates, or mixtures thereof. The aqueous coating composition may comprise a mixture of two or more water-soluble alkali metal silicates. The water-soluble alkali metal silicate can be supplied as an aqueous solution typically comprising 5% to 80%, 10% to 70%, or 15% to 60% by dry weight, of the alkali metal silicate, based on the weight of such aqueous solution.

Components (C) and (D) are present in amounts to provide a dry weight ratio of component (C) to component (D) (i.e., the ratio of dry weight of the alkali metal silicate to dry weight of the triphosphonic acid derivative) in a range of 1.2 to 3.7, and can be 1.2 or more, 1.4 or more, 1.5 or more, 1.6 or more, 1.7 or more, 1.8 or more, 1.9 or more, even 2.0 or more while at the same time is 3.7 or less, and can be 3.6 or less, 3.5 or less, 3.4 or less, 3.3 or less, 3.2 or less, 3.1 or less, 3.0 or less, 2.8 or less, 2.5 or less, 2.2 or less, or even 2.0 or less, and desirably, 1.5 to 3.0.

The aqueous coating composition of the present invention may comprise tannic acid, gallic acid, pyrogallol, or citric acid; a salt thereof; or combinations thereof (component (E)). Component (E) can be a mixture of two or more of tannic acid, gallic acid, pyrogallol, and citric acid; a mixture of their salts; or combinations thereof. Desirably, component (E) comprises or consists of tannic acid, a salt thereof, or combinations thereof. Component (E) may be present in the aqueous coating composition at a concentration of from 40% to 52%, and can be 40% or more, 42% or more, 44% or more, 45% or more, 46% or more, even 48% or more while at the same time is 52% or less, and can be 51% or less, 50% or less, 49% or less, 48% or less, 47% or less, 46% or less, or even 45% or less, and desirably, 45% to 49%, by weight based on the weight of the emulsion polymer.

The aqueous coating composition of the present invention may comprise or be free of one or more pigments. “Pigments” herein refers to materials that are capable of materially contributing to the opacity or hiding capability of a composition. Such material typically has a refractive index greater than 1.8. Inorganic pigments typically include metal oxides. Examples of suitable inorganic pigments include titanium dioxide (TiO₂), zinc sulfide, lithopone, carbon black, iron oxide red, iron oxide black, lemon chrome yellow, or mixtures thereof. Organic pigments typically include prussian blue, organic pigment yellow, organic pigment red, anticorrosive pigments, or mixtures thereof. Preferably, the pigment is selected from TiO₂, carbon black, or mixtures thereof. The pigment may be present at a total concentration of from zero to 60%, from 10% to 50%, from 15% to 40%, or from 20% to 35%, by weight based on the weight of the aqueous coating composition. The pigment may comprise or be free of anticorrosive pigments. “Anticorrosive pigment” refers to a pigment that can prevent or retard corrosion of steel through chemical reactions or chelate. Suitable anticorrosive pigments may include, for example, zinc phosphate, zinc molybdate, zinc oxide, aluminum tripolyphosphate, zinc phosphate molybdenum, calcium-modified zinc phosphate, organic molecule-modified zinc phosphate, or mixtures thereof. The anticorrosive pigment may be present at a concentration of from zero to 10%, and can be zero or more, 0.5% or more, 1% or more, 2% or more, 3% or more, even 4% or more while at the same time is generally at a concentration of 10% or less, and can be 9% or less, 8% or less, 7% or less, or even 6% or less, and can be 5.5% or less, 5% or less, 4.5% or less, 4% or less, 3.5% or less, 3% or less, 2.5% or less, 2% or less, 1.5% or less, 1% or less, or even 0.5% or less, by weight based on the weight of the aqueous coating composition.

The aqueous coating composition of the present invention may comprise or be free of one or more extenders. “Extenders” herein refers to particulate inorganic materials having a refractive index of less than or equal to 1.8 and greater than 1.3. Examples of suitable extenders include barium sulphate, talc, calcium carbonate, clay, calcium sulfate, aluminum silicates, other silicates (that are other than component (D)), zeolites, mica, diatomaceous earth, solid or hollow glass, ceramic beads, nepheline syenite, feldspar, diatomaceous earth, calcined diatomaceous earth, talc (hydrated magnesium silicate), silica, alumina, kaolin, pyrophyllite, perlite, baryte, wollastonite, opaque polymers such as ROPAQUE™ Ultra E available from The Dow Chemical Company (ROPAQUE is a trademark of The Dow Chemical Company), or mixtures thereof. The aqueous coating composition may comprise the extender at a concentration of zero to 60%, and can be 10% to 50%, 15% to 40%, or 20% to 35%, by weight based on the weight of the aqueous coating composition.

The aqueous coating composition of the present invention may comprise or be free of one or more defoamers. “Defoamers” herein refer to chemical additives that reduce and hinder the formation of foam. Defoamers may be silicone-based defoamers, mineral oil-based defoamers, ethylene oxide/propylene oxide-based defoamers, alkyl polyacrylates and mixtures thereof. Suitable commercially available defoamers may include, for example, TEGO Airex 901 W, TEGO Airex 902 W and TEGO Foamex 1488 polyether siloxane copolymer emulsions available from TEGO, BYK-022 and BYK-024 silicone defoamer available from BYK, and mixtures thereof. The defoamer may be present generally at a concentration of zero to 0.5%, and can be 0.02% to 0.4%, or 0.04% to 0.2%, by weight based on the weight of the aqueous coating composition.

The aqueous coating composition of the present invention may comprise or be free of one or more thickeners, also known as “rheology modifiers”. Thickeners may include polyvinyl alcohol (PVA), clay materials, acid derivatives, acid copolymers, urethane associate thickeners (UAT), polyether urea polyurethanes (PEUPU), polyether polyurethanes (PEPU), or mixtures thereof. Examples of suitable thickeners include alkali swellable emulsions (ASE) such as sodium or ammonium neutralized acrylic acid polymers; hydrophobically modified alkali swellable emulsions (HASE) such as hydrophobically modified acrylic acid copolymers; associative thickeners such as hydrophobically modified ethoxylated urethanes (HEUR); and cellulosic thickeners such as methyl cellulose ethers, hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, and 2-hydoxypropyl cellulose. Desirably, the thickener is HEUR. The thickener may be present at a concentration of zero to 1.0%, and can be 0.05% to 0.6%, or 0.1% to 0.4%, by weight based on the weight of the aqueous coating composition.

The aqueous coating composition of the present invention may comprise or be free of one or more wetting agents. “Wetting agents” herein refer to chemical additives that reduce the surface tension of a composition, causing the composition to be more easily spread across or penetrate the surface of a substrate. Wetting agents may be polycarboxylates, anionic, zwitterionic, or non-ionic. Suitable commercially available wetting agents may include, for example, SURFYNOL 104 and SURFYNOL TG nonionic wetting agent based on an actacetylenic diol available from Evonik, BYK-190, TEGO-750W and TEGO-755W solution of a high molecular weight block polymer with pigment affinic groups available from BYK and Evonik, respectively, BYK-346 and BYK-349 polyether-modified siloxanes both available from BYK, or mixtures thereof. The wetting agent may be present at a concentration of zero to 0.6%, and can be 0.1% to 0.5%, or 0.2% to 0.4%, by weight based on the weight of the aqueous coating composition.

The aqueous coating composition of the present invention may comprise or be free of one or more coalescents. “Coalescents” herein refer to slow-evaporating solvents that fuse polymer particles into a continuous film under ambient condition. Examples of suitable coalescents include 2-n-butoxyethanol, dipropylene glycol n-butyl ether, propylene glycol n-butyl ether, dipropylene glycol methyl ether, propylene glycol methyl ether, propylene glycol n-propyl ether, diethylene glycol monobutyl ether, ethylene glycol monobutyl ether, ethylene glycol monohexyl ether, triethylene glycol monobutyl ether, dipropylene glycol n-propyl ether, n-butyl ether, or mixtures thereof. Preferred coalescents include dipropylene glycol n-butyl ether, ethylene glycol monobutyl ether, diethylene glycol monobutyl ether, n-butyl ether, or mixtures thereof. The coalescent may be present at a concentration of zero to 10%, and can be 0.2% to 8%, or 1% to 6%, by weight based on the weight of the aqueous coating composition.

The aqueous coating composition of the present invention may comprise or be free of one or more dispersants. Dispersants can be polyacrylic acid or polymethacrylic acid or maleic anhydride with various monomers such as styrene, acrylate or methacrylate esters, diisobutylene, and other hydrophilic or hydrophobic comonomers; salts thereof; or mixtures thereof. The dispersant may be present at a concentration of zero to 2%, and can be 0.1% to 1.5%, or 0.2% to 1%, by weight based on the weight of the aqueous coating composition.

In addition to the components described above, the aqueous coating composition of the present invention may comprise any one or combination of the following additives: buffers, neutralizers, humectants, mildewcides, biocides, anti-skinning agents, colorants, anti-oxidants, plasticizers, leveling agents, adhesion promoters, and grind vehicles. These additives may be present at a total concentration of zero to 10%, and can be 0.1% to 5%, or 0.2% to 1%, by weight based on the weight of the aqueous coating composition. The aqueous coating composition may also comprise water at a concentration of 30% to 90%, and can be 40% to 80%, or 50% to 70%, by weight based on the weight of the aqueous coating composition.

The aqueous coating composition of the present invention can be prepared by admixing component (A) typically in an aqueous dispersion, component (B) typically in an aqueous solution, component (D), and component (E) with component (C), and optionally, the polyfunctional carboxylic hydrazide, the pigment and other optional components described above. All components except component (C) such as ATMP in the aqueous coating composition may be mixed in any order, followed by mixing with component (C) finally. For example, the emulsion polymer and the dicarboxylic acid and/or the salt thereof (preferably in an aqueous solution) are mixed first, prior to mixing with other components if present. Alternatively, components (A) may be first mixed with component (D), component (E), and other optional components if present, and then component (B) may be added, followed by addition of component (C) (desirably, ATMP) at last. The pigments and/or extenders are preferably mixed with the dispersant to form a slurry of pigments and/or extender.

The aqueous coating composition of the present invention is useful for rust conversion. The aqueous coating composition can be applied to, and adhered to, a corrosion susceptible substrate such as a metal substrate. The metal substate may include, for example, ferrous metals such as cast iron, weld seams, and carbon steel. The aqueous coating composition can be directly applied onto the substrate, particularly, unpretreated substrates, such as rusted metal surfaces. The aqueous coating composition has the capability of rust conversion (i.e., converting or reacting rust on metal surfaces), that is, after applying the aqueous coating composition of the present invention, the original porous rust on the surface of the substrate can be converted to a dark-purple coordination compound, thereby forming a coating film (i.e., coating) on the substrate and such coating film is ready to be applied with waterborne acrylic coating compositions. The coordination compound is insoluble to water and organic solvents.

The aqueous coating composition of the present invention is particularly suitable for forming a base coat of a multilayer coating that further comprises one or more topcoats that are made from aqueous top coating compositions that are other than the aqueous coating composition of the present invention described above. The present application also relates to a multilayer coating comprising a base coat made from the aqueous coating composition the present invention and a top coat made from the aqueous top coating composition, where the base coat resides between the top coat and a substrate. The substrate is as described above. The multilayer coating may have a film thickness of 40 micrometers (μm) to 60 μm. The multilayer coating may have properties including, for example, (1) flash rust resistance with flash rust grade “0” according to ISO 8501-4: 2006 after exposure at 23° C. and 90% relative humidity (R. H.) for 24 hours; (II) good early water resistance as indicated by blister ratings of “8M” or better, and desirably, “8F” or “10”; (III) good adhesion to the substrate as indicated by adhesion classification of “4B” or better, and desirably, “5B”, according to ASTM D 3359; and (IV) good water resistance as indicated by blister ratings of “8M” or better, and desirably, “8F” or “10”. These properties can be measured according to the test methods described in the Examples section below.

The aqueous top coating composition useful in the present invention can be an acrylic top coating composition that comprises an acrylic emulsion polymer useful as a binder. The acrylic emulsion polymer in the top coating composition may include the emulsion polymer described above, and commercially available acrylic binders such as MAINCOTE™ HG-100, MAINCOTE™ HG-300, and PRIMAL™ AS-8508 emulsion polymers all available from The Dow Chemical Company (MAINCOTE and PRIMAL are trademarks of The Dow Chemical Company). The top coating composition may also comprise one or more than one of the following components: a pigment, an extender, a defoamer, a thickener, a wetting agent, a coalescent a dispersant, and a polyfunctional carboxylic hydrazide containing at least two hydrazide groups per molecule, which can be those as described above. The top coating composition may comprise one or more optional additives described above.

The present invention relates to a method of preparing the coating (desirably, the multilayer coating). The method comprises the steps of: (i) providing the aqueous coating composition of the present invention, (ii) applying the aqueous coating composition directly on a corrosion susceptible substrate, and (iii) drying, or allowing to dry, the applied aqueous coating composition, thereby forming the base coat on the substrate. When the coating is the multilayer coating, the method may further comprise: (iv) applying the aqueous acrylic top coating composition to the base coat obtained from step (iii); and (v) drying, or allowing to dry, the applied aqueous top coating composition to form a topcoat, such that the base coat resides between the substrate and the top coat. The coating is suitable for marine protective coatings, general industrial finishes, metal protective coatings, automotive coatings, traffic paints, Exterior Insulation and Finish Systems (EIFS), wood coatings, coil coatings, plastic coatings, can coatings, architectural coatings, and civil engineering coatings, and particularly suitable for metal protective coatings. The substrate used in the method can be an unpretreated substrate. The method can be free of a step of pretreating the substrate surface (e.g., by polishing), while the coating obtained therefrom still has the properties described above.

Applying the coating composition (e.g., the aqueous coating composition of the present invention or the aqueous acrylic top coating composition) to the substrate can be conducted by incumbent means including brushing, dipping, rolling and spraying. The aqueous coating composition is preferably applied by spraying. The standard spray techniques and equipment for spraying such as air-atomized spray, air spray, airless spray, high volume low pressure spray, and electrostatic spray such as electrostatic bell application, and either manual or automatic methods can be used. After the coating composition has been applied to a substrate, the composition can be dried, or allowed to dry, to form a coating film (e.g., the base coat or the top coat) at temperatures ranging from 0 to 35° C., or at an elevated temperature, for example, from 35 to 60′° C.

### Examples

Some embodiments of the invention will now be described in the following Examples, where all parts and percentages are by weight (wt/%), where wt % is relative to the emulsion polymer weight unless otherwise specified. Materials for use in samples are described herein below.

| Abbreviation | Description | Source |
|---|---|---|
| ST | Styrene | Langyuan Chemical Co., Ltd. |
| PEM | Phosphoethyl methacrylate | Solvay |
| AAEM | Acetoacetoxyethyl methacrylate | Eastman |
| BA | Butyl acrylate | The Dow Chemical Company |
| DAAM | Diacetone acrylamide | Kyowa Hakko Chemical Co., Ltd. |
| ADH | Adipic dihydrazide | Kyowa Hakko Chemical Co., Ltd. |
| MEUR | N-(2-Methacryloyloxyethyl) ethylene urea | Evonik Industries |
| MAA | Methacrylic acid | Sinopharm Chemical Reagent Co., |
| AA | Acrylic acid | Ltd. |
| n-DDM | n-Dodecyl mercaptan | |
| t-BHP | t-Butyl hydroperoxide | |
| IAA | Isoascorbic acid | |
| EDTA | Ethylenediamine tetraacetic acid | |
| APS | Ammonium persulphate | |
| Neutralizer | Aqueous ammonia (25% aqueous solution) | |
| NaNO₂ | Sodium nitrite (flash rust inhibitor) | |
| Sodium metasilicate | sodium metasilicate nonahydrate (Na₂SiO₃•9H₂O) | |
| Sebacic acid | HOOC(CH₂)₈COOH | |
| Succinic acid | HOOCCH₂CH₂COOH | |
| Tannic acid | A multiple hydroxyl phenol | |
| ATMP | Amino trimethylene phosphonic acid (50% aqueous solution) | |
| | 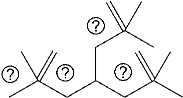 | |
| Adipic acid | HOOC(CH₂)₄COOH | TCI |
| Coalescent | TEXANOL ™ ester alcohol | Eastman Chemical Company |
| Dispersant | OROTAN ™ 681 polymethacrylic acid with hydrophobic comonomers | The Dow Chemical Company |
| Rheology modifier | ACRYSOL ™ RM-8W nonionic urethane rheology modifier | The Dow Chemical Company |
| Wetting agent | SURFYNOL ™ TG nonionic surfactant based on an actacetylenic diol | Evonik industries |
| Defoamer | TEGOTM Airex 902W polyether siloxane copolymer emulsion | Evonik Industries |
| Pigment | Ti-PURE ™ R-706 titanium dioxide | DuPont |
| FES 32 | DISPONIL ™ FES 32 alcohol ethoxylate sulphate surfactant | BASF |
| AB/20 | RHODAPEX ™ AB/20 alcohol ethoxylate sulphate surfactant | Solvay |
| B-11 | POLYSTEP ™ B-11 alcohol ethoxylate sulphate surfactant | STEPAN |
| Binder | MAINCOTE ™ HG-100 (solids content: 47.5%), MAINCOTE ™ HG-300 | The Dow Chemical Company |
| | (solids content: 40.5%), and PRIMAL ™ AS-8508 (solids content: 48%) | |
| | waterborne acrylic polymer binder emulsions | |

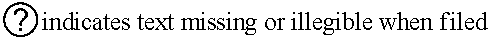

OROTAN, RETAN, ACRYSOL, MAINCOTE, and PRIMAL are trademarks of The Dow Chemical Company.

Aqueous polymer dispersions comprising emulsion polymers for use as in conversion coasting composition samples were prepared according to synthesis process described below:

### Synthesis of Aqueous Polymer Dispersion “PD 40”

Deionized (DI) water (409 grams (g)), FES 32 surfactant (31%, 55 g), ST (892 g), BA (683 g), AA (33 g), PEM (6 g), MEUR (50%, 10 g), and n-DDM (4 g) were mixed together to produce a stable monomer emulsion. To DI water (728 g) under a nitrogen (N₂) atmosphere at 90° C., were added FES 32 surfactant (31%, 6 g), the monomer emulsion (54 g) and APS (6 g) in DI water (18 g) followed by DI water (10 g) to form a reaction mixture. The remaining monomer emulsion, APS (2.5 g) in DI water (64 g) and ammonia (25%, 6 g) in DI water (62 g) were then added at 88° C. over 180 minutes (min) followed by DI water (25 g). At the end of polymerization, FeSO₄ (0.01 g) in DI water (3 g) mixed with EDTA sodium salt (0.02 g) in DI water (3 g), a solution of t-BHP (4.9 g) dissolved in DI water (26 g), and a solution of IAA (2.3 g) in DI water (45 g) were all added at 60° C., and then ammonia (53 g) in DI water (25 g) was added at 50° C. to obtain the aqueous dispersion.

Synthesis of aqueous polymer dispersion “PD 76”

A stage 1 monomer emulsion (ME1) was prepared by mixing DI water (288 g), AB/20 surfactant (28.5%, 29 g), BA (560 g), ST (585 g), PEM (16 g), MAA (30 g), DAAM (31 g), MEUR (50%, 4.3 g), and n-DDM (2.5 g) together to produce a stable monomer emulsion. A stage 2 monomer emulsion (ME2) was prepared by mixing DI water (124 g), AB/20 surfactant (28.5%, 13 g), BA (105 g), ST (425 g), MEUR (50%, 2 g), and n-DDM (1.1 g) together to produce a stable monomer emulsion.

To a 5-liter, four-necked round bottom flask equipped with a paddle stirrer, a thermocouple, nitrogen inlet, and reflux condenser was added DI water (879 g) and stirring was initiated. The contents of the flask were heated to 90° C. under a N₂ atmosphere. AB/20 surfactant (28.5%, 10 g), MAA (5.3 g), ME1 (89 g), and APS (5.0 g) in DI water (46 g) were added to the flask, followed by a rinse with DI water (30 g). The remaining ME1, APS (1.6 g) in DI water (45 g) and ammonia (25%, 15 g) in DI water (43 g) were then added over 87 min. After completion of ME1 feed, DI water (30 g) was added as a rinse. ME2 and APS (0.7 g) in DI water (20 g) were then added over 33 min. After completion of the ME2 feed, DI water (30 g) was added as a rinse. The contents of the flask were maintained at 87-89° C. during the additions. At the end of polymerization, a mixture of FeSO₄·7H₂O (0.014 g) in DI water (5 g) and EDTA sodium salt (0.028 g) in DI water (5 g), a solution of t-BHP (70%, 3.4 g t-BHP dissolved in 36 g DI water), and a solution of IAA (2.3 g IAA dissolved in 38 g DI water) were all added to the flask at 60° C., and then ammonia (25%, 26 g) in DI water (26 g) and ADH (19 g) in DI water (67 g) were added to the flask at 50° C. to obtain the aqueous dispersion.

### Synthesis of Aqueous Polymer Dispersion “PD 00”

A stage 1 monomer emulsion (ME1) was prepared by mixing DI water (296 g), AB/20 surfactant (28.5%, 32 g), BA (405 g), ST (685 g), PEM (16 g), MAA (31 g), AAEM (128 g), MEUR (50%, 4.5 g), and n-DDM (2.6 g) together to produce a stable monomer emulsion. A stage 2 monomer emulsion (ME2) was prepared by mixing DI water (127 g), AB/20 surfactant (28.5%, 14 g), BA (209 g), ST (340 g), MEUR (50%, 1.9 g), and n-DDM (1.1 g) together to produce a stable monomer emulsion.

To a 5-liter, four-necked round bottom flask equipped with a paddle stirrer, a thermocouple, nitrogen inlet, and reflux condenser was added DI water (899 g) and stirring was initiated. The contents of the flask were heated to 90° C. under a N₂ atmosphere. AB/20 surfactant (28.5%, 7.5 g), MAA (5.5 g), ME1 (92 g), and APS (5.1 g) in DI water (46 g) were added to the flask, followed by a rinse with DI water (30 g). The remaining ME1, APS (1.6 g) in DI water (45 g) and ammonia (25%, 15 g) in DI water (43 g) were then added over 87 min. After completion of ME1 feed, DI water (30 g) was added as a rinse. ME2 and APS (0.7 g) in DI water (20 g) were then added over 33 min. After completion of the ME2 feed, DI water (30 g) was added as a rinse. The contents of the flask were maintained at 87-89° C. during the additions. At the end of polymerization, a mixture of FeSO₄·7H₂O (0.014 g) in DI water (5 g) and EDTA sodium salt (0.028 g) in DI water (5 g), a solution of t-BHP (70%, 3.5 g t-BHP dissolved in 36 g DI water), and a solution of IAA (2.4 g IAA dissolved in 38 g DI water) were all added to the flask at 60° C., and then ammonia (25%, 39 g) in DI water (26 g) were added to the flask at 50° C. to obtain the aqueous dispersion.

### Synthesis of Aqueous Polymer Dispersion “PD 29”

A stage 1 monomer emulsion (ME1) was prepared by mixing DI water (301 g), B-11 surfactant (54%, 15 g), BA (560 g), ST (572 g), PEM (26 g), MAA (30 g), DAAM (43 g), MEUR (50%, 4.3 g), and n-DDM (5 g) together to produce a stable monomer emulsion. A stage 2 monomer emulsion (ME2) was prepared by mixing DI water (130 g), B-11 surfactant (54%, 7.6 g), BA (105 g), ST (425 g), MEUR (50%, 2 g), and n-DDM (1.0 g) together to produce a stable monomer emulsion.

To a 5-liter, four-necked round bottom flask equipped with a paddle stirrer, a thermocouple, nitrogen inlet, and reflux condenser was added DI water (780 g) and stirring was initiated. The contents of the flask were heated to 90° C. under a N₂ atmosphere. B-11 surfactant (54%, 4.7 g), MAA (5.3 g), ME1 (89 g) and APS (5 g) in DI water (44 g) were added to the flask, followed by a rinse with DI water (45 g). The remaining ME1, APS (1.5 g) in DI water (71 g) and ammonia (25%, 15 g) in DI water (52 g) were then added over 87 min. After completion of ME1 feed, DI water (30 g) was added as a rinse. ME2 and APS (0.7 g) in DI water (30 g) were then added over 33 min. After completion of the ME2 feed, DI water (30 g) was added as a rinse. The contents of the flask were maintained at 87-89° C. during the additions. At the end of polymerization, a mixture of FeSO₄·7H₂O (0.008 g) in DI water (5 g) and EDTA sodium salt (0.016 g) in DI water (5 g), a solution of t-BHP (70%, 3.4 g t-BHP dissolved in 43 g DI water), and a solution of IAA (2.3 g IAA dissolved in 78 g DI water) were all added to the flask at 60° C., and then ammonia (25%, 26 g) in DI water (26 g) and ADH (26 g) in DI water (67 g) were added to the flask at 50° C. to obtain the aqueous dispersion.

### Synthesis of Aqueous Polymer Dispersion “PD 31”

A stage 1 monomer emulsion (ME1) was prepared by mixing DI water (301 g), B-11 surfactant (54%, 15 g), BA (570 g), ST (597 g), PEM (26 g), MAA (30 g), DAAM (9 g), MEUR (50%, 4.3 g), and n-DDM (5 g) together to produce a stable monomer emulsion. A stage 2 monomer emulsion (ME2) was prepared by mixing DI water (130 g), B-1l surfactant (54%, 7.6 g), BA (105 g), ST (425 g), MEUR (50%, 2 g), and n-DDM (1.0 g) together to produce a stable monomer emulsion.

To a 5-liter, four-necked round bottom flask equipped with a paddle stirrer, a thermocouple, nitrogen inlet, and reflux condenser was added DI water (780 g) and stirring was initiated. The contents of the flask were heated to 90° C. under a N₂ atmosphere. B-11 surfactant (54%, 4.7 g), MAA (5.3 g), ME1 (89 g), and APS (5 g) in DI water (44 g) were added to the flask, followed by a rinse with DI water (45 g). The remaining ME1, APS (1.5 g) in DI water (71 g) and ammonia (25%, 15 g) in DI water (52 g) were then added over 87 min. After completion of ME1 feed, DI water (30 g) was added as a rinse. ME2 and APS (0.7 g) in DI water (30 g) were then added over 33 min. After completion of the ME2 feed, DI water (30 g) was added as a rinse. The contents of the flask were maintained at 87-89° C. during the additions. At the end of polymerization, a mixture of FeSO₄·7H₂O (0.008 g) in DI water (5 g) and EDTA sodium salt (0.016 g) in DI water (5 g), a solution of t-BHP (70%, 3.4 g t-BHP dissolved in 43 g DI water), and a solution of IAA (2.3 g IAA dissolved in 78 g DI water) were all added to the flask at 60° C., and then ammonia (25%, 26 g) in DI water (26 g) and ADH (5.3 g) in DI water (14 g) were added to the flask at 50° C. to obtain the aqueous dispersion.

### Synthesis of Aqueous Polymer Dispersion “PD 41”

A stage 1 monomer emulsion (ME1) was prepared by mixing DI water (301 g), B-11 surfactant (54%, 15 g), BA (560 g), ST (580 g), PEM (35 g), MAA (26 g), DAAM (31 g), MEUR (50%, 4.3 g), and n-DDM (5 g) together to produce a stable monomer emulsion. A stage 2 monomer emulsion (ME2) was prepared by mixing DI water (130 g), B-11 surfactant (54%, 7.6 g), BA (105 g), ST (425 g), MEUR (50%, 2 g), and n-DDM (1.0 g) together to produce a stable monomer emulsion.

To a 5-liter, four-necked round bottom flask equipped with a paddle stirrer, a thermocouple, nitrogen inlet, and reflux condenser was added DI water (780 g) and stirring was initiated. The contents of the flask were heated to 90° C. under a N₂ atmosphere. B-11 surfactant (54%, 4.7 g), MAA (5.3 g), ME1 (89 g), and APS (5 g) in DI water (44 g) were added to the flask, followed by a rinse with DI water (45 g). The remaining ME1, APS (1.5 g) in DI water (71 g) and ammonia (25%, 15 g) in DI water (52 g) were then added over 87 min. After completion of ME1 feed, DI water (30 g) was added as a rinse. ME2 and APS (0.7 g) in DI water (30 g) were then added over 33 min. After completion of the ME2 feed, DI water (30 g) was added as a rinse. The contents of the flask were maintained at 87-89° C. during the additions. At the end of polymerization, a mixture of FeSO₄·7H₂O (0.008 g) in DI water (5 g) and EDTA sodium salt (0.016 g) in DI water (5 g), a solution of t-BHP (70%, 3.4 g t-BHP dissolved in 43 g DI water), and a solution of IAA (2.3 g IAA dissolved in 78 g DI water) were all added to the flask at 60° C., and then ammonia (25%, 26 g) in DI water (26 g) and ADH (18.5 g) in DI water (48 g) were added to the flask at 50° C. to obtain the aqueous dispersion.

### Synthesis of Aqueous Polymer Dispersion “PD 42”

A stage 1 monomer emulsion (ME1) was prepared by mixing DI water (301 g), B-11 surfactant (54%, 15 g), BA (564 g), ST (585 g), PEM (18 g), MAA (35 g), DAAM (31 g), MEUR (50%, 4.3 g), and n-DDM (5 g) together to produce a stable monomer emulsion. A stage 2 monomer emulsion (ME2) was prepared by mixing DI water (130 g), B-11 surfactant (54%, 7.6 g), BA (105 g), ST (425 g), MEUR (50%, 2 g), and n-DDM (1.0 g) together to produce a stable monomer emulsion.

To a 5-liter, four-necked round bottom flask equipped with a paddle stirrer, a thermocouple, nitrogen inlet, and reflux condenser was added DI water (780 g) and stirring was initiated. The contents of the flask were heated to 90° C. under a N₂ atmosphere. B-11 surfactant (54%, 4.7 g), MAA (5.3 g), ME1 (89 g), and APS (5 g) in DI water (44 g) were added to the flask, followed by a rinse with DI water (45 g). The remaining ME1, APS (1.5 g) in DI water (71 g) and ammonia (25%, 15 g) in DI water (52 g) were then added over 87 min. After completion of ME1 feed, DI water (30 g) was added as a rinse. ME2 and APS (0.7 g) in DI water (30 g) were then added over 33 min. After completion of the ME2 feed, DI water (30 g) was added as a rinse. The contents of the flask were maintained at 87-89° C. during the additions. At the end of polymerization, a mixture of FeSO₄·7H₂O (0.008 g) in DI water (5 g) and EDTA sodium salt (0.016 g) in DI water (5 g), a solution of t-BHP (70%, 3.4 g t-BHP dissolved in 43 g DI water), and a solution of IAA (2.3 g IAA dissolved in 78 g DI water) were all added to the flask at 60° C., and then ammonia (25%, 26 g) in DI water (26 g) and ADH (18.5 g) in DI water (48 g) were added to the flask at 50° C. to obtain the aqueous dispersion.

The as prepared polymer dispersions were characterized according to the test methods below and properties are given in Table 1:

### Solids Content

Solids content of aqueous polymer dispersions was determined by weighting 0.7±0.1 g of a sample (wet weight of the sample is denoted as “W1”), putting the sample into an aluminum pan (weight of aluminum pan is denoted as “W2”) in an oven at 150° C. for 25 min, and then cooling to room temperature and weighting the aluminum pan with the dried sample with total weight denoted as “W3”. “W3−W2” refers to dry or solids weight of the sample. The solids content is calculated by (W3−W2)/W1*100%.

### GPC Analysis

Number average molecular weight (Mₙ) of an emulsion polymer in an aqueous polymer dispersion was measured by GPC analysis performed generally by Agilent 1200. A sample was dissolved in tetrahydrofuran (THF)/formic acid (FA) (5%) with a concentration of 2 milligrams per milliliter (mg/mL), stirred for over one hour, stored at room temperature overnight, and then filtered through 0.45 μm polytetrafluoroethylene (PTFE) filter prior to GPC analysis. The GPC analysis was conducted under the following conditions:

Column: One PLgel GUARD column (10 μm, 50 millimeters (mm)×7.5 mm), Two Mixed B columns (7.8 mm×300 mm) in tandem; column temperature: 40° C.; mobile phase: THF/FA (5%); flow rate: 1.0 mL/minute; Injection volume: 100 μL; detector: Agilent Refractive Index detector, 40° C.; and calibration curve: PL Polystyrene I Narrow standards with molecular weights ranging from 2329000 to 580 g/mol, using polynom 3 fitness.

TABLE 1
Properties of Aqueous Polymer Dispersion

| Polymer | Fox Tg, | | Solids | Particle | Mn, |
|---|---|---|---|---|---|
| Dispersion | ° C. | pH | content, % | size, nm | g/mol |
| PD 40 | 22 | 7.86 | 47.88 | 115 | N,A. |
| PD 76 | 22 | 6.84 | 47.36 | 115 | 22214 |
| PD 00 | 22 | 9.04 | 47.46 | 129 | N.A. |
| PD 31 | 22 | 7.03 | 48.39 | 124 | 15056 |
| PD 29 | 22 | 7.18 | 47.97 | 121 | 18892 |
| PD 42 | 22 | 6.99 | 48.48 | 122 | 15774 |
| PD 41 | 22 | 7.02 | 47.84 | 123 | 18754 |

*Fox Tg of emulsion polymers in the polymer dispersion was calculated by the Fox equation. Particle size was measured by a Brookhaven BI-90 Plus Particle Size Analyzer.
N.A.—not available.

### Preparation of Dicarboxylic Acid Solutions

(1) Preparation of an aqueous solution of neutralized sebacic acid (“Sebacic Acid Solution”): Sebacic acid (6.00 g), aqueous ammonia solution (25%, 19.53 g) and water (1.74 g) were mixed and stirred to give a transparent solution comprising sebacic acid, mono-ammonium sebate, bis-ammonium sebate, or mixtures thereof.
(2) Preparation of aqueous solution of neutralized succinic acid (“Succinic Acid Solution”): Succinic acid (6.00 g), aqueous ammonia solution (25%, 19.53 g) and water (1.74 g) were mixed and stirred to give a transparent solution comprising succinic acid, mono-ammonium succinate, bis-ammonium succinate, or mixtures thereof.
(3) Preparation of an aqueous solution of neutralized adipic acid (“Adipic Acid Solution”): Adipic acid (6.00 g), aqueous ammonia solution (25%, 19.53 g) and water (1.74 g) were mixed and stirred to give a transparent solution comprising adipic acid, mono-ammonium adipate, bis-ammonium adipate, or mixtures thereof.

### Aqueous Acrylic Top Coating Compositions

Formulations for aqueous acrylic top coating compositions are given in Table 2, with the amount of each component reported in grams (g). A pigment grind was prepared by mixing the components in the grind using a high speed grinder at 1500 revolutions per minute (RPM) for 20 m. The binder was premixed with water and aqueous ammonia solution to adjust a pH value to above 8.5 to obtain a premix. Then the pigment grind was added into the premix, followed by addition of TEXANOL ester alcohol. The resulting mixture was further added the aqueous solution of NaNO₂ (flash rust inhibitor). Finally. ACRYSOL RM-8W rheology modifier and water were added to adjust viscosities of the resulting samples to 80-90 kreb units (KU) as measured by using BROOKFIELD™ KU-3 Viscometer at room temperature, thereby forming aqueous acrylic top coating compositions.

TABLE 2
Aqueous acrylic top coating compositions

| | Top coat 1 | Top coat 2 | Top coat 3 |
|---|---|---|---|
| Component | (“TC1”) | (“TC2”) | (“TC3”) |
| Grind | | | |
| Water | 42 | 42 | 42 |
| OROTAN ™ 681 | 7.8 | 7.8 | 7.8 |
| SURFYNOL ™ TG | 2 | 2 | 2 |
| Aqueous ammonia, 28% | 2 | 2 | 2 |
| TEGO ™ Airex 902W | 0.46 | 0.46 | 0.46 |
| Ti-PURE ™ R-706 | 209.24 | 209.24 | 209.24 |
| Water | 42 | 42 | 42 |
| Subtotal | 305.5 | 305.5 | 305.5 |
| Letdown | | | |
| Premix | | | |
| MAINCOTE ™ HG-100 binder | 536 | | |
| MAINCOTE ™ HG-300 binder | | 628.64 | |
| PRIMAL ™ AS-8508 binder | | | 546 |
| Water | 50 | 5 | 50 |
| Aqueous ammonia, 28% | 4 | 4 | 4 |
| End of premix | 590.00 | 637.64 | 590.00 |
| Aqueous NaNO₂ solution (15%) | 9.0 | 9.0 | 9.0 |
| ACRYSOL ™ RM-8W | 2.1 | 2.1 | 2.1 |
| TEXANOL ™ ester alcohol | 45.48 | 45.48 | 45.48 |
| Water | 25 | | 25 |
| Total | 977.08 | 999.72 | 977.08 |

### Rust Conversion Coating Composition Samples

Formulations for direct to metal (DTM) rust conversion coating compositions are given in Tables 3 and 4, with the amount of each component reported in grams (g). For preparing the compositions for IEs 1-11 given in Table 3, tannic acid was dissolved in a mixture of ethanol and water, followed by addition of isopropanol. The resulting solution was added the aqueous polymer dispersion prepared above (as a binder), followed by addition of TEXANOL ester alcohol. Then the sodium silicate solution and the dicarboxylic acid solution prepared above were added in sequence. The resulting mixture was further added ATMP solution, followed by ammonia aqueous solution to adjust pH above 7.0. Finally, the resulting compositions were filtered by 325 mesh (45 μm) screen to separate gels if any. The compositions used in CEs 1-18 were prepared substantially the same as above, except some components were omitted or different as given in Table 4. All the obtained rust conversion coating composition samples were evaluated according to the following test methods, and properties and characterization results are given in Tables 3 and 4:

### Preparation of Coated Panels

A sand blasting steel panel (Model H⋅HONG™ Standard Test Panel from Guangdong Honghong Industrial Co., Ltd.) was first exposed to a salt spray environment (5% sodium chloride fog in Q-Fog cyclic corrosion tester, model No. Q-FOG/CCT1100) for 24 hours to generate rust on the panel surface. Then the rusted panel was washed with DI water to clean the salt on the surface. After drying, the panel was burnished with 240 grits abrasive paper to remove loose rust on the panel surface while rust tightly adherent to the panel was left unremoved and remained on the panel surface. The panel surface was further treated with alcohol to remove anti-rust oil.

A rust conversion coating composition sample listed in Tables 3 and 4 (1.5 g) was brushed over the obtained panel by art brushes (Model 6713 from Shanghai Oil Paint Brush Manufactory). Then a second layer of the rust conversion coating composition sample was brushed 2 hours after the first layer was applied. The surface of the coated panel turned dark black-purple gradually while the panel was left under ambient conditions (23° C. and 50% R.H.) for 48 hours. Then an aqueous acrylic top coating composition sample (1.5 g) prepared above as listed in Table 2 was further brushed over the panel by art brushes (same source as above), which gave the resulting coated panel with a final dry film thickness of 18 μm to 20 μm. Then the as prepared coated panels (hereinafter “Coated Panels”) were characterized according to the test methods below:

### Flash Rust Resistance Test

The Coated Panels prepared above were immediately put into an environmental chamber (23° C. and 90% R.H.) for 24 hours. After that, the Coated Panels were removed to rate flash rust grades according to ISO 8501-4: 2006 as shown in Table A and rust ranking described below. Acceptable flash rust grade is “0”.

TABLE A
Description of surface appearance for four flash rust grades

| | |
|---|---|
| 0 | No flash rust |
| | A surface which, when viewed without magnification, exhibits no yellow/brown rust layer or spots. The coating |
| | film is uniform with no stains. |
| L | Light flash rust |
| | A surface which, when viewed without magnification, exhibits small quantities of a yellow/brown rust layer |
| | through which the coating film can be seen. The rust (seen as a discoloration) can be evenly distributed or present |
| | in patches, but it will be tightly adherent and not easily removed by gentle wiping with a cloth. |
| M | Medium flash rust |
| | A surface which, when viewed without magnification, exhibits a layer of yellow/brown rust that obscures the |
| | original coating film. The rust layer can be evenly distributed or present in patches, but it will be reasonably well |
| | adherent and it will lightly mark a cloth that is gently wiped over the surface. |
| H | Heavy flash rust |
| | A surface which, when viewed without magnification, exhibits a layer of red-yellow/brown rust that obscures the |
| | original coating film and is loosely adherent. The rust layer can be evenly distributed or present in patches and it |
| | will readily mark a cloth that is gently wiped over the surface. |

Rust ranking may include rusting degree, where “S” represents spots, “G” represents general, and “P” represents pin point; and rating by surface rusted percentage, where “10” means less than or equal to 0.01%, “9” means greater than 0.01% and up to 0.03%, “8” means greater than 0.03% and up to 0.1%, “7” means greater than 0.1% and up to 0.3%, “6” means greater than 0.3% and up to 1.0%, “5” means greater than 1.0% and up to 3.0%, “4” means greater than 3.0% and up to 10.0%, “3” means greater than 10.0% and up to 16.0%, “2” means greater than 16.0% and up to 33.0%, “1” means greater than 33.0% and up to 50.0%, and “0” means greater than 50.0%. Acceptable rust ranking is “10”.

### Early Water Resistance Test

The Coated Panels prepared above were dried at 23° C. and 50% R.H. for 2 hours, and then partially immersed into DI water for 1 day at 23° C. Then the surface of the panels after immersion was visually observed and then blister ratings were conducted in accordance with ASTM D714-02 (2009) comprising a number and/or one or more letters, as shown in Table B. The letter F, M, MD, or D is a qualitative representation of the density of blisters. The number refers to the size of the blister, whereby 2 is the largest size, 8 is the smallest size, and 10 is no blister. The bigger the number, the smaller the size of blister. Panels with blister ratings of “8M” or better (desirably, “8F” or “10”) are acceptable, indicating good early water resistance.

TABLE B
Blister Rating Criteria

| Density of blister | Abbreviation | Size of Blister | Rating |
|---|---|---|---|
| Few | F | Very Big blister | 2 |
| Medium | M | Big blister | 4 |
| Medium dense | MD | Small to middle blister | 6 |
| Dense | D | Smallest blister seen by | 8 |
| | | unaided eye | |
| | | No blister | 10 |

### Water Resistant Test

The Coated Panels prepared above were dried at 23° C. and 50% R.H. for 7 days, and then partially immersed into DI water for 1 day at 23° C. Then the surface of the panels after immersion was visually observed and blister ratings were conducted according to the same procedure and criteria as described above in the early water resistance test. Panels with blister ratings of “8M” or better (desirably, “8F” or “10”) are acceptable, indicating good water resistance.

### Adhesion Test

The Coated Panels prepared above were dried at 23° C. and 50% R.H. for 7 days, and then evaluated for adhesion properties according to ASTM D 3359. Panels with classification of “4B” or better (desirably, “5B”) are acceptable, indicating good adhesion to the steel panel surface.

Properties and characterization of the Coated Panels are given in Tables 3 and 4. As shown in Table 3, rust conversion coating samples of IEs 1-11 each comprising a multistage emulsion polymer binder that contains specific contents of structural units of PEM and DAAM in combination with sebacic acid, tannic acid, sodium silicate, and ATMP at specific concentrations (after rust conversion) provided synergetic effects on significant improvement on properties of coatings comprising different aqueous acrylic top coats, including flash rust resistance at the same time early water resistance, water resistance, and adhesion properties.

In contrast, rust conversion coating composition samples free of any one or more of the claimed components and/or outside the claimed ranges failed one or more requirements of the above properties after rust conversion. Replacing sebacic acid with equivalent succinic acid or adipic acid (CEs 2 and 3) resulted in a significant decrease in flash rust resistance and adhesion properties as compared to IE 1. Flash rust resistance properties of CEs 2 and 3 were even worse than the sample without addition of dicarboxylic acid (CE 1). In the absence of ATMP, CE 5 sample showed compromised flash rust resistance and significantly decreased adhesion properties. In the absence of silicate (CE 6), tannic acid (CE 7), or both ATMP and silicate (CE 9), all properties of these samples were dramatically compromised. Replacing ATMP with phosphorous acid gave slightly worse flash rust resistance and early water resistance (CE 12). The sole use of the binder PD 76 without the combination of tannic acid, sodium silicate and ATMP resulted in poor flash rust resistance and adhesion properties even in the presence of sebacic acid (CE 8). CE 10 sample with a silicate/ATMP ratio of 1.0 showed decreased flash rust resistance and poor adhesion properties, while early water resistance of CE 18 sample with a silicate/ATMP ratio of 4 was compromised. When using AAEM instead of DAAM for preparing a binder in the rust conversion coating (CE 11), early water resistance and adhesion properties were compromised though flash rust resistance was maintained, which indicates that early water resistance and adhesion properties are not necessarily related to flash rust resistance. CE 4 sample containing the acrylic binder PD 40 and post-added ADH in the base coat showed no significant improving on flash rust resistance, though adhesion was slightly improved. CE 13 using the emulsion polymer comprising 0.5 wt % of structual units of DAAM in the rust conversion coating showed unsatisfactory flash rust resistance and adhesion properties. CE 14 sample comprising 4.0 wt % of sebacic acid in the rust conversion coating showed poor adhesion and early water resistance properties. CEs 15 and 16 samples using too low or too high loadings of tannic acid (30 wt % and 70 wt % based on dry polymer, respectively) in the rust conversion coating failed all the requirements for flash rust resistance, adhesion, and early water resistance properties. CE 17 showed that too low loadings of ATMP (20 wt %) in the rust conversion coating resulted in poor flash rust resistance and adhesion properties. Moreover, CEs 16 and 17 samples both have ratios of tannic acid to ATMP of higher than 1.75 (1.97 and 2.42, respectively).

TABLE 3
Coating Composition Samples IEs 1-11

| Component | IE 1 | IE 2 | IE 3 | IE 4 | IE 5 | IE 6 |
|---|---|---|---|---|---|---|
| Rust conversion | | | | | | |
| coating composition | | | | | | |
| Tannic acid | 7.5 | 7.5 | 7.5 | 7.5 | 7.5 | 7.5 |
| Ethanol | 30 | 30 | | 30 | 30 | 30 |
| Water | 35 | 5 | | 35 | 35 | 35 |
| Isopropanol | 2.5 | 2.5 | 2.5 | 2.5 | 2.5 | 2.5 |
| PD 76 | 32.5 | 32.5 | 32.5 | 32.5 | 32.5 | |
| PD 29 | | | | | | 32.5 |
| PD 41 | | | | | | |
| PD 42 | | | | | | |
| TEXANOL ester alcohol | 2.76 | 2.76 | 2.76 | 2.76 | 2.76 | 2.7 |
| Sodium silicate solution (5%) | 165 | 220 | 330 | 165 | 165 | 165 |
| Sebacic Acid solution (22%) | 0.84 | 0.84 | 0.84 | 0.84 | 0.84 | 0.84 |
| Succinic Acid solution (22%) | | | | | | |
| Adipic Acid solution (22%) | | | | | | |
| ATMP solution (50%) | 11 | 11 | 11 | 11 | 11 | 11 |
| Top coating composition | TC1 | TC1 | TC1 | TC2 | TC3 | TC1 |
| Characterization | | | | | | |
| Sebacic acid content | 1.20% | 1.20% | 1.20% | 1.20% | 1.20% | 1.20% |
| ATMP content | 35.63% | 35.63% | 35.63% | 35.63% | 35.63% | 35.63% |
| Silicate/phosphonic acid ratio | 1.5 | 2 | 3 | 1.5 | 1.5 | 1.5 |
| Tannic acid content | 48.58% | 48.58% | 48.58% | 48.58% | 48.58% | 48.58% |
| Flash rust grade | 0 | 0 | 0 | 0 | 0 | 0 |
| Rust ranking | 10 | 10 | 10 | 10 | 10 | 10 |
| Adhesion classification | 4B | 4B | 5B | 4B | 4B | 4B |
| Early water resistance | 8M | 8M | 8M | 8M | 8M | 8M |
| Water resistance | 8M | 8F | 8M | 8M | 8M | 8F |

| Component | IE 7 | IE 8 | IE 9 | IE 10 | IE 11 |
|---|---|---|---|---|---|
| Rust conversion | | | | | |
| coating composition | | | | | |
| Tannic acid | 7.5 | 7.5 | 7.5 | 7.5 | 6.95 |
| Ethanol | 30 | 30 | 30 | 30 | 30 |
| Water | 35 | 35 | 79.85 | 35 | 35 |
| Isopropanol | 2.5 | 2.5 | 2.5 | 2.5 | 2.5 |
| PD 76 | | | 32.5 | 32.5 | 32.5 |
| PD 29 | | | | | |
| PD 41 | 32.5 | | | | |
| PD 42 | | 32.5 | | | |
| TEXANOL ester alcohol | 2.76 | 2.76 | 2.76 | 2.76 | 2.76 |
| Sodium silicate solution (5%) | 165 | 165 | 115.72* | 165 | 165 |
| Sebacic Acid solution (22%) | 0.84 | 0.84 | 0.84 | 2.10 | 0.84 |
| Succinic Acid solution (22%) | | | | | |
| Adipic Acid solution (22%) | | | | | |
| ATMP solution (50%) | 11 | 11 | 15.43 | 11 | 11 |
| Top coating composition | TC1 | TC1 | TC1 | TC1 | TC1 |
| Characterization | | | | | |
| Sebacic acid content | 1.20% | 1.20% | 1.20% | 2.99% | 1.20% |
| ATMP content | 35.63% | 35.63% | 49.98% | 35.63% | 35.63% |
| Silicate/phosphonic acid ratio | 1.5 | 1.5 | 1.5 | 1.5 | 1.5 |
| Tannic acid content | 48.58% | 48.58% | 48.58% | 48.58% | 45.02% |
| Flash rust grade | 0 | 0 | 0 | 0 | 0 |
| Rust ranking | 10 | 10 | 10 | 10 | 10 |
| Adhesion classification | 4B | 4B | 4B | 4B | 4B |
| Early water resistance | 8F | 8F | 8M | 8M | 8F |
| Water resistance | 8F | 8M | 8M | 8M | 8F |

*In Tables 3 and 4:
“Sodium silicate solution” was prepared by dissolving sodium metasilicate solids in water to obtain solutions at different concentrations of 5%, 10%, and 15% by weight. Sodium silicate solution (5% solution) was used unless otherwise stated. IE 9 sample use the 10% solution and CE 18 sample uses the 15% solution.
“Sebacic acid content” refers to the content of —OOC—R—COO— segments calculated by the weight of originally added sebacic acid (raw material) in forming Sebacic Acid Solutions used in preparing the samples relative to the dry weight of the emulsion polymer in the rust conversion coating composition.
All contents in tables 3 and 4 refer to weight percentages relative to the dry weight of emulsion polymer in the rust conversion coating composition unless otherwise stated.
“Silicate/phosphonic acid ratio” refers to the dry weight ratio of sodium silicate/ATMP, except, in CE 12, it refers to the dry weight ratio of sodium silicate/phosphorous acid.

TABLE 4
Coating Composition Samples CEs 1-18

| Component | CE 1 | CE 2 | CE 3 | CE 4 | CE 5 | CE 6 | CE 7 | CE 8 | CE 9 | CE 10 |
|---|---|---|---|---|---|---|---|---|---|---|
| Rust conversion coating | | | | | | | | | | |
| composition | | | | | | | | | | |
| Tannic acid | 7.5 | 7.5 | 7.5 | 7.5 | 7.5 | 7.5 | | | 7.5 | 7.5 |
| Ethanol | 30 | 30 | 30 | 30 | 30 | 30 | 30 | 30 | 30 | 30 |
| Water | 35 | 35 | 35 | 35 | 5 | 135 | | 55 | 112 | 70 |
| Isopropanol | 2.5 | 2.5 | 2.5 | 2.5 | 2.5 | 2.5 | 2.5 | 2.5 | 2.5 | 2.5 |
| PD 76 | 32.5 | 32.5 | 32.5 | | 32.5 | 32.5 | 32.5 | 32.5 | 32.5 | 32.5 |
| PD 31 | | | | | | | | | | |
| PD 40 | | | | 32.5 | | | | | | |
| PD 00 | | | | | | | | | | |
| TEXANOL ester alcohol | 2.76 | 2.76 | 2.76 | 2.76 | 2.76 | 2.76 | 2.76 | 2.76 | 2.76 | 2.76 |
| ADH | | | | 0.16 | | | | | | |
| Sodium Silicate Solution | 165 | 165 | 165 | 165 | 165 | | 165 | | | 110 |
| (5%) | | | | | | | | | | |
| Sebacic Acid Solution (22%) | | | | 0.84 | 0.84 | 0.84 | 0.84 | 0.84 | 0.84 | 0.84 |
| Succinic Acid Solution (22%) | | 0.49 | | | | | | | | |
| Adipic Acid Solution (22%) | | | 0.61 | | | | | | | |
| ATMP solution (50%) | 11 | 11 | 11 | 11 | | 11 | 11 | | | 11 |
| Phosphorous acid | | | | | | | | | | |
| Top coating composition | TC1 | TC1 | TC1 | TC1 | TC1 | TC1 | TC1 | TC1 | TC1 | TC1 |
| Characterization | | | | | | | | | | |
| Sebacic acid content | N.A. | N.A. | N.A. | 1.20% | 1.20% | 1.20% | 1.20% | 1.20% | 1.20% | 1.20% |
| ATMP content | 35.63% | 35.63% | 35.63% | 35.63% | N.A. | 35.63% | 35.63% | N.A. | N.A. | 35.63% |
| Silicate/phosphonic acid ratio | 1.5 | 1.5 | 1.5 | 1.5 | N.A. | N.A. | 1.5 | N.A. | N.A. | 1 |
| Tannic acid content | 48.58% | 48.58% | 48.58% | 48.58% | 48.58% | 48.58% | N.A. | N.A. | 48.58% | 48.58% |
| Flash rust grade | L | M | M | H | H | L | L | H | L | H |
| Rust ranking | 7S | 5S | 5G | 1G | 1G | 5S | 7P | 1G | 5S | 5S |
| Adhesion classification | 0B | 0B | 1B | 2B | 3B | 2B | 3B | 2B | 2B | 3B |
| Early water resistance | 8D | 8D | 8D | 6MD | 8M | 6D | 6M | 6D | 8D | 8MD |
| Water resistance | 8D | 8M | 8M | 8M | 8M | 6D | 6M | 8MD | 8D | 8F |

| Component | CE 11 | CE 12 | CE 13 | CE 14 | CE 15 | CE 16 | CE 17 | CE 18 |
|---|---|---|---|---|---|---|---|---|
| Rust conversion coating | | | | | | | | |
| composition | | | | | | | | |
| Tannic acid | 7.5 | 7.5 | 7.5 | 7.5 | 4.63 | 10.81 | 7.5 | 7.5 |
| Ethanol | 30 | 30 | 30 | 30 | 30 | 30 | 30 | 30 |
| Water | 35 | 40.5 | 35 | 35 | 37.87 | 31.69 | 112.12 | 53.33 |
| Isopropanol | 2.5 | 2.5 | 2.5 | 2.5 | 2.5 | 2.5 | 2.5 | 2.5 |
| PD 76 | | 32.5 | | 32.5 | 32.5 | 32.5 | 32.5 | 32.5 |
| PD 31 | | | 32.5 | | | | | |
| PD 40 | | | | | | | | |
| PD 00 | 32.5 | | | | | | | |
| TEXANOL ester alcohol | 2.76 | 2.76 | 2.76 | 2.76 | 2.76 | 2.76 | 2.76 | 2.76 |
| ADH | | | | | | | | |
| Sodium Silicate Solution | 165 | 165 | 165 | 165 | 165 | 165 | 92.7 | 146.67* |
| (5%) | | | | | | | | |
| Sebacic Acid Solution (22%) | 0.84 | 0.84 | 0.84 | 2.81 | 0.84 | 0.84 | 0.84 | 0.84 |
| Succinic Acid Solution (22%) | | | | | | | | |
| Adipic Acid Solution (22%) | | | | | | | | |
| ATMP solution (50%) | 11 | | 11 | 11 | 11 | 11 | 6.18 | 11 |
| Phosphorous acid | | 5.50 | | | | | | |
| Top coating composition | TC1 | TC1 | TC1 | TC1 | TC1 | TC1 | TC1 | TC1 |
| Characterization | | | | | | | | |
| Sebacic acid content | 1.20% | 1.20% | 1.20% | 4.00% | 1.20% | 1.20% | 1.20% | 1.20% |
| ATMP content | 35.63% | N.A. | 35.63% | 35.63% | 35.63% | 35.63% | 20.02% | 35.63% |
| Silicate/phosphonic acid ratio | 1.5 | 1.5 | 1.5 | 1.5 | 1.5 | 1.5 | 1.5 | 4 |
| Tannic acid content | 48.58% | 48.58% | 48.58% | 48.58% | 29.99% | 70.02% | 48.58% | 48.58% |
| Flash rust grade | 0 | L | M | 0 | L | L | H | 0 |
| Rust ranking | 10 | 7P | 5S | 10 | 9S | 7S | 3S | 10 |
| Adhesion classification | 2B | 4B | 0B | 0B | 1B | 0B | 1B | 4B |
| Early water resistance | 4MD | 8D | 8M | 6M | 6F | 6M | 8F | 4M |
| Water resistance | 6MD | 8D | 10 | 8M | 10 | 8F | 10 | 8M |

1. An aqueous coating composition comprising,
(A) an emulsion polymer comprising:
(i) from 0.48% to 1.5% by weight of structural units of an ethylenically unsaturated phosphorous-containing monomer,
(ii) from 0.7% to 3% by weight of structural units of diacetone (meth)acrylamide,
(iii) from 10% to 80% by weight of structural units of a vinyl aromatic monomer,
(iv) structural units of an alkyl (meth)acrylate, and
(v) from zero to 5% by weight of structural units of an α, β-ethylenically unsaturated carboxylic acid, a salt thereof, or mixtures thereof;
(B) a dicarboxylic acid, a salt thereof, or mixtures thereof; wherein the dicarboxylic acid has the structure of formula (I): 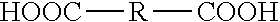
where R is alkylene, alkenylene, alkynylene, cycloalkylene, cycloalkenylene, cycloalkynylene, arylene, or heterocyclic arylene; containing 6 to 18 carbon atoms; and
wherein (B) the dicarboxylic acid, the salt thereof, or mixtures thereof is present in an amount to provide —OOC—R—COO— segments at a concentration of from 1.1% to 3.8% by weight;
(C) from 30% to 60% by weight of a thio-, amido-, or imido-derivative of triphosphonic acids, a salt thereof, or mixtures thereof;
(D) a water-soluble alkali metal silicate that is present in an amount to provide a dry weight ratio of (D) the water-soluble alkali metal silicate to (C) the thio-, amido-, or imido-derivative of triphosphonic acids, the salt thereof, or mixtures thereof, in a range of 1.2 to 3.7; and
(E) from 40% to 52% by weight of tannic acid, gallic acid, pyrogallol, or citric acid; a salt thereof; or combinations thereof;
where weight percentages are relative to the emulsion polymer weight.

2. The aqueous coating composition of claim 1, wherein the dicarboxylic acid is selected from sebacic acid, dodecanedioic acid, suberic acid, anchoic acid, undecanedioic acid, eicosanedioic acid, and mixtures thereof.

3. The aqueous coating composition of claim 1, wherein component (C) the thio-amido-, or imido-derivative of triphosphonic acids, the salt thereof, or mixtures thereof is selected from amino trimethylene phosphonic acid, and amino triethylene phosphonic acid; salts thereof; and combinations thereof.

4. The aqueous coating composition of claim 1, wherein component (E) is tannic acid.

5. The aqueous coating composition of claim 1, wherein the ethylenically unsaturated phosphorous-containing monomer is selected from phosphoethyl methacrylate, phosphoethyl acrylate, allyl ether phosphate, phosphopropyl methacrylate, phosphobutyl methacrylate, and mixtures thereof.

6. The aqueous coating composition of claim 1, wherein the emulsion polymer has a glass transition temperature of from −10° C. to 50° C. as calculated by a Fox equation.

7. The aqueous coating composition of claim 1, wherein the emulsion polymer has a number average molecular weight of from 8,000 to 60,000 g/mol as measured by gel permeation chromatography.

8. The aqueous coating composition of claim 1, wherein the emulsion polymer is a multistage polymer comprising, based on the weight of the multistage polymer, from 50% to 90% by weight of a polymer A and from 10% to 50% by weight of a polymer B;
wherein the polymer A comprises, based on the weight of the polymer A, from 0.3% to 2.4% by weight of structural units of the ethylenically unsaturated phosphorous-containing monomer, from 1% to 6% by weight of structural units of the diacetone (meth)acrylamide, and from 10% to 75% by weight of structural units of the vinyl aromatic monomer;
wherein the polymer B comprises, based on the weight of the polymer B, from zero to 2.5% by weight of structural units of the ethylenically unsaturated phosphorous-containing monomer, from zero to 2.5% by weight of structural units of the diacetone (meth)acrylamide, and from 10% to 100% by weight of structural units of the vinyl aromatic monomer; and
wherein at least one of the polymer A and polymer B also comprises structural units of the alkyl (meth)acrylate.

9. The aqueous coating composition of claim 1, further comprising a polyfunctional carboxylic hydrazide containing at least two hydrazide groups per molecule.

10. A method of preparing a coating, comprising:
(i) providing the aqueous coating composition of claim 1,
(ii) applying the aqueous coating composition directly on a corrosion susceptible substrate, and
(iii) drying, or allowing to dry, the applied aqueous coating composition, thereby forming a base coat on the substrate; and optionally,
(iv) applying an aqueous top coating composition comprising an acrylic emulsion polymer to the base coat obtained from step (iii); and (v) drying, or allowing to dry, the applied aqueous top coating composition to form a top coat, such that the base coat resides between the substrate and the top coat.
